(19) United States
(12) Patent Application Publication
(10) Pub. No.: US 2016/0364532 A1
(43) Pub. Date: Dec. 15, 2016

(54) SEARCH TOOLS FOR MEDICAL CODING

(71) Applicant: Nuance Communications, Inc., Burlington, MA (US)

(72) Inventors: Nadine Honeycutt, National City, CA (US); Derek Honeycutt, Encinitas, CA (US)

(73) Assignee: Nuance Communications, Inc., Burlington, MA (US)

(21) Appl. No.: 14/738,738

(22) Filed: Jun. 12, 2015

(51) Int. Cl. G06F 19/00

(52) U.S. Cl. CPC G06F 19/327; G06F 19/322

(57) ABSTRACT

Techniques for facilitating medical code searching include receiving an input search query, and processing the input search query to retrieve from a data set of hierarchically-related medical codes one or more matching codes relevant to the input search query. In response to the input search query, one or more selectable items may be presented, corresponding to the matching codes retrieved from the data set of hierarchically-related medical codes. A selection may be received from the user of one or more of the presented selectable items as satisfying the input search query, and the user may be permitted to include in the selection both first and second selectable items corresponding to first and second matching codes at the same level of hierarchy, as both satisfying the input search query.

### BACKGROUND

Medical documentation is an important process in the healthcare industry. Most healthcare institutions maintain a longitudinal medical record (e.g., spanning multiple observations and/or treatments over time) for each of their patients, documenting, for example, the patient's history, encounters with clinical staff within the institution, treatment received, and/or plans for future treatment. Such documentation facilitates maintaining continuity of care for the patient across multiple encounters with various clinicians over time. In addition, when an institution's medical records for large numbers of patients are considered in the aggregate, the information contained therein can be useful for educating clinicians as to treatment efficacy and best practices, for internal auditing within the institution, for quality assurance, etc.

Historically, each patient's medical record was maintained as a physical paper folder, often referred to as a “medical chart”, or “chart”. Each patient's chart would include a stack of paper reports, such as intake forms, history and immunization records, laboratory results and clinicians' notes. Following an encounter with the patient, such as an office visit, a hospital round, a surgical procedure, etc., the clinician conducting the encounter would provide a narrative note about the encounter, to be included in the patient's chart. Such a note could include, for example, a description of the reason(s) for the patient encounter, an account of any vital signs, test results and/or other clinical data collected during the encounter, one or more diagnoses determined by the clinician from the encounter, and/or a description of a plan for further treatment. Often, the clinician would verbally dictate the note into an audio recording device or a telephone giving access to such a recording device, to spare the clinician the time it would take to prepare the note in written form. Later, a medical transcriptionist would listen to the audio recording and transcribe it into a text document, which would be inserted on a piece of paper into the patient's chart for later reference.

Currently, many healthcare institutions are transitioning or have transitioned from paper documentation to electronic medical record systems, in which patients' longitudinal medical information is stored in a data repository in electronic form. Besides the significant physical space savings afforded by the replacement of paper record-keeping with electronic storage methods, the use of electronic medical records also provides beneficial time savings and other opportunities to clinicians and other healthcare personnel. For example, when updating a patient's electronic medical record to reflect a current patient encounter, a clinician need only document the new information obtained from the encounter, and need not spend time entering unchanged information such as the patient's age, gender, medical history, etc. Electronic medical records can also be shared, accessed and updated by multiple different personnel from local and remote locations through suitable user interfaces and network connections, eliminating the need to retrieve and deliver paper files from a crowded file room.

Another modern trend in healthcare management is the importance of medical coding for documentation and billing purposes. In the medical coding process, documented information regarding a patient encounter, such as the patient's diagnoses and clinical procedures performed, is classified according to one or more standardized sets of codes for reporting to various entities such as payment providers (e.g., health insurance companies that reimburse clinicians for their services). In the United States, some such standardized code systems have been adopted by the federal government, which then maintains the code sets and recommends or mandates their use for billing under programs such as Medicare.

For example, the International Classification of Diseases (ICD) numerical coding standard, developed from a European standard by the World Health Organization (WHO), was adopted in the U.S. in version ICD-9-CM (Clinically Modified). It is mandated by the Health Insurance Portability and Accountability Act of 1996 (HIPAA) for use in coding patient diagnoses. The Centers for Disease Control (CDC), the National Center for Health Statistics (NCHS), and the Centers for Medicare and Medicaid Services (CMS) are the U.S. government agencies responsible for overseeing all changes and modifications to ICD-9-CM, and a new version ICD-10-CM is scheduled for adoption in 2015. Whereas ICD-9-CM included both diagnosis and procedure codes, ICD-10-CM includes only diagnosis codes, and procedure codes form a separate code set ICD-10-PCS (Procedure Coding System).

Another example of a standardized code system adopted by the U.S. government is the Current Procedural Terminology (CPT) code set, which classifies clinical procedures in five-character alphanumeric codes. The CPT code set is owned by the American Medical Association (AMA), and its use is mandated by CMS as part of the Healthcare Common Procedure Coding System (HCPCS). CPT forms HCPCS Level I, and HCPCS Level II adds codes for medical supplies, durable medical goods, non-physician healthcare services, and other healthcare services not represented in CPT. CMS maintains and distributes the HCPCS Level II codes with quarterly updates.

Conventionally, the coding of a patient encounter has been performed by a designated professional, referred to as a “medical coder” or simply “coder,” with expert training in medical terminology and documentation as well as the standardized code sets being used and the relevant regulations. The coder would read the available documentation from the patient encounter, such as the clinicians' narrative reports, laboratory and radiology test results, etc., and determine the appropriate codes to assign to the encounter. The coder might make use of a medical coding system, such as a software program running on suitable hardware, that would display the documents from the patient encounter for the coder to read, and allow the coder to manually input the appropriate codes into a set of fields for entry in the record. Once finalized, the set of codes entered for the patient encounter could then be sent to a payment provider, which would typically determine the level of reimbursement for the encounter according to the particular codes that were entered.

### SUMMARY

One type of embodiment is directed to a method comprising: processing an input search query, via execution of stored instructions by at least one processor, to retrieve from a data set of hierarchically-related medical codes one or more matching codes relevant to the input search query; presenting to a user via an electronic user interface, in response to the input search query, one or more selectable items, each selectable item corresponding to one of the matching codes retrieved from the data set of hierarchically-related medical codes; receiving from the user via the electronic user interface a selection of one or more of the presented selectable items as satisfying the input search query, wherein the user is permitted to include in the selection a first selectable item and a second selectable item as both satisfying the input search query, the first selectable item corresponding to a first matching code at a same level of hierarchy as a second matching code corresponding to the second selectable item; and outputting information corresponding to the selected matching codes.

Another type of embodiment is directed to at least one computer-readable storage medium storing computer-executable instructions that, when executed, perform a method comprising: processing an input search query to retrieve from a data set of hierarchically-related medical codes one or more matching codes relevant to the input search query; presenting to a user via an electronic user interface, in response to the input search query, one or more selectable items, each selectable item corresponding to one of the matching codes retrieved from the data set of hierarchically-related medical codes; receiving from the user via the electronic user interface a selection of one or more of the presented selectable items as satisfying the input search query, wherein the user is permitted to include in the selection a first selectable item and a second selectable item as both satisfying the input search query, the first selectable item corresponding to a first matching code at a same level of hierarchy as a second matching code corresponding to the second selectable item; and outputting information corresponding to the selected matching codes.

Another type of embodiment is directed to apparatus comprising at least one processor, and at least one processor-readable storage medium storing processor-executable instructions that, when executed by the at least one processor, perform a method comprising: processing an input search query to retrieve from a data set of hierarchically-related medical codes one or more matching codes relevant to the input search query; presenting to a user via an electronic user interface, in response to the input search query, one or more selectable items, each selectable item corresponding to one of the matching codes retrieved from the data set of hierarchically-related medical codes; receiving from the user via the electronic user interface a selection of one or more of the presented selectable items as satisfying the input search query, wherein the user is permitted to include in the selection a first selectable item and a second selectable item as both satisfying the input search query, the first selectable item corresponding to a first matching code at a same level of hierarchy as a second matching code corresponding to the second selectable item; and outputting information corresponding to the selected matching codes.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an exemplary operating environment for a system in accordance with some embodiments;

FIGS. 2A and 2B illustrate an exemplary user interface screen in accordance with some embodiments;

FIG. 3 illustrates part of a hierarchy of medical codes that may be used in accordance with some embodiments;

FIGS. 4A-4D illustrate an exemplary user interface screen in accordance with some embodiments;

FIGS. 5A-5D illustrate exemplary user interface screens in accordance with some embodiments;

FIGS. 6A and 6B illustrate exemplary user interface screens in accordance with some embodiments;

FIGS. 7A and 7B illustrate an exemplary user interface screen in accordance with some embodiments;

FIG. 8 illustrates an exemplary user interface screen in accordance with some embodiments;

FIG. 9 illustrates an exemplary user interface screen in accordance with some embodiments;

FIG. 10 illustrates an exemplary user interface screen in accordance with some embodiments;

FIGS. 11A and 11B illustrate an exemplary user interface screen in accordance with some embodiments;

FIG. 12 illustrates an exemplary user interface screen in accordance with some embodiments;

FIG. 13 illustrates an exemplary user interface screen in accordance with some embodiments;

FIG. 14 illustrates an exemplary method in accordance with some embodiments;

FIG. 15 illustrates an exemplary method in accordance with some embodiments; and

FIG. 16 illustrates an exemplary computer system via which some embodiments may be implemented.

### DETAILED DESCRIPTION

The inventors have appreciated that specificity can be of great importance in medical coding. Some commonly used coding systems, such as ICD codes, are organized in a hierarchy in which the most specific codes are designated as subcodes of less specific codes. In taxonomic terms, the more specific codes are children of more generic codes, and the more generic codes are parents of their corresponding more specific codes. For example, in ICD-9-CM, the more generic code 401 for “Essential hypertension” is a parent of three more specific child codes: 401.0 for “Malignant essential hypertension,” 401.1 for “Benign essential hypertension,” and 401.9 for “Unspecified essential hypertension.” In some cases, there may be more than one level of hierarchy; e.g., a child code that is more specific than its own parent code may in turn be more generic than, and function as a parent to, its own child code(s). For example, ICD-9-CM code 250 for “Diabetes mellitus” has ten children (codes 250.0 through 250.9), each of which has four children of its own (e.g., code 250.0 has child codes 250.00 through 250.03).

The inventors have appreciated that it can be important for healthcare providers to document the medical codes that apply to a given patient encounter at the most specific level available, for a variety of reasons. For instance, payment providers such as Medicare, Medicaid, and insurance companies may deny or delay reimbursement to medical providers if their documentation is not coded at the required level of specificity.

For example, reimbursement may be denied for treatment of a patient whose diagnosis is coded generally as ICD-9-CM 401 (“Essential hypertension”) because the payment provider requires documentation that the diagnosis is more specifically ICD-9-CM 401.0 (“Malignant essential hypertension,” which may justify a particular treatment) as opposed to, e.g., ICD-9-CM 401.1 (“Benign essential hypertension,” which may not call for that particular treatment). Alternatively, in some cases a payor might delay reimbursement until the medical provider updates the documentation with the more specific code. There are also non-financial reasons why a high level of specificity may be desirable in medical coding, such as for accurate quality assurance review, and for completeness of information communication between a patient's physicians (e.g., between a patient's specialist such as a cardiologist and the patient's primary care physician) for continuity of care.

To achieve these objectives, medical coders are often trained to code documents at the highest level of specificity possible. However, the inventors have appreciated that coders often make mistakes, and/or may be limited by the level of specificity (or lack thereof) that the clinician has included in his/her narrative report. Often, the clinician may not have the coding system in mind when writing or dictating his/her report of the patient encounter, and may not realize what specific information the coder may need to see for most efficient billing, and/or may not even be aware of the particular terminology used in the coding system. For example, the clinician may not be aware of a need to mention that a treatment was performed or prescribed because the patient was diagnosed with “malignant essential hypertension,” as opposed to simply saying, “Patient was hypertensive,” or perhaps equivalently, “Patient's blood pressure was chronically elevated” (nonstandard terminology with respect to the ICD coding system). The inventors have further appreciated that commonly used medical code sets are too complex for most clinicians to take it upon themselves to code their own documentation or to take time to determine what specific terms should be mentioned to allow the documentation to be coded as specifically as possible. Rather, a medical coder, different from the clinician, may have the job of attempting to assign codes to documentation that the clinician created without reference to the code set, and may send the clinician a request for certain specific information (termed a “clarification”) if the clinician has omitted something that may be required for complete coding. For example, if the clinician merely noted, “Patient was hypertensive,” the clinician may be sent a clarification stating, “The medical record reflects a clinical finding of essential hypertension; please clarify whether benign or malignant.”

The inventors have appreciated that denials and/or delays in payment processes, and the need for documentation to be returned to authoring clinicians for clarification, can create inefficiencies in already complex and burdensome healthcare logistics. The inventors have recognized moreover that such issues have the potential to dramatically increase with the adoption of the ICD-10-CM coding standard, which employs a much larger and more complex code set than ICD-9-CM. Whereas the ICD-9-CM code set contains approximately 18,000 codes, the ICD-10-CM code set contains approximately 150,000 codes. Moreover, the mapping between ICD-9-CM codes and ICD-10-CM/PCS codes is not straightforward, and not every ICD-9-CM code has a single corresponding ICD-10-CM or ICD-10-PCS code with the same title. For example, the generic diagnosis “Diabetes mellitus” corresponds to ICD-9-CM code 250, which includes 40 subcodes at the highest level of specificity (in this case, grandchild codes of code 250, i.e., child codes of child codes of code 250). In ICD-10-CM, however, “Diabetes mellitus” has five different generic codes E08, E09, E10, E11 and E13, which together include some 206 subcodes at the highest available level of specificity. The inventors have recognized that for clinicians and coders who may be more familiar with the terminology and code hierarchy levels and organization of ICD-9-CM, it may be difficult to come up with the right terms and to find the appropriate codes in the transition to ICD-10.

The inventors have recognized that clinicians, coders, and/or other healthcare professionals may benefit from an electronic tool to assist them in searching for the appropriate medical codes applicable to a patient encounter, and/or to assist in utilizing corresponding terminology to provide supporting documentation for such medical codes. The inventors have further recognized that such users may benefit from an interactive tool to guide them from more generic to more specific documentation and/or coding, to exercise available opportunities to enhance specificity potentially at an early stage of documentation. The inventors have appreciated that such a tool may be useful in reducing the number of clarifications needed, and/or in reducing instances of reimbursement denials and/or delays, in medical documentation and billing.

Accordingly, some embodiments described herein relate to tools for assisting clinicians, coders and/or other users in identifying appropriate medical codes for documenting patient encounters, and/or in improving the textual documentation supporting such codes, which may address one or more of the above-discussed shortcomings of traditional methods, and/or that may provide one or more of the foregoing benefits. However, some embodiments are not limited to any of these benefits, and it should be appreciated that some embodiments may not provide any of the above-discussed benefits and/or may not address any of the above-discussed deficiencies that the inventors have recognized in conventional techniques.

In some embodiments, a code search tool may be configured to allow a user to input a search query via an electronic user interface (UI). In some embodiments, the user may enter the search query to find one or more codes in a set of hierarchically-related medical codes that are applicable to a patient encounter that the user is documenting. For example, in some embodiments, the user may search for one or more codes, and/or one or more descriptive names corresponding to the code(s), corresponding to one or more clinical diagnoses exhibited by the patient and/or to one or more clinical procedures performed or to be performed on the patient. In some embodiments, the tool may process the input search query to retrieve one or more relevant codes from the code set, and may present a number of selectable items via the UI, corresponding to the codes retrieved for the search query.

In some embodiments, a first screen of search results may be presented, with selectable items corresponding to matching codes, not all of which are at the most specific level of the hierarchy in the code set. For example, if the user were to input a search query of “diabetes” in search of an ICD-9-CM code for the patient's diagnosis, in some embodiments instead of presenting the 40 most specific subcodes 250.00 through 250.93 for the user to sift through all at once, the system may instead first present the generic code 250 (“Diabetes mellitus”) for the user to select. By doing so, the user may confirm that “diabetes mellitus” as a general category satisfies the search query, and then in some embodiments the system may proceed to present further selectable items corresponding to the selected generic code's subcodes (i.e., to child codes of the selected parent code), to enhance the specificity of the user's ultimate selection for documenting the diagnosis, procedure, or other coded entity. The inventors have recognized that presenting code search results in stages that walk the user from more generic to more specific coding decisions in some embodiments may engage the user in a thought process that may promote accuracy, efficiency, and/or specificity of medical coding.

In some embodiments, the user may be permitted to select more than one code at the same level of hierarchy in the code set as concurrently satisfying the same input search query. For example, in response to a user's search query for an ICD-10-CM diagnosis code for “fractured femur” and initial selection of generic parent code S72 (“Fracture of femur”), the user may be presented with selectable items corresponding to child codes S72.0 through S72.9 corresponding to different types of femur fractures. In some embodiments, the user may be permitted to select more than one of these selectable items, thus indicating that two or more codes at the same level of hierarchy satisfy the input search query and represent diagnoses applicable to the patient. For example, the user could select both code S72.3 (“Fracture of shaft of femur”) and its sibling code S72.4 (“Fracture of lower end of femur”), e.g., to concurrently document two different fractures suffered by the patient, without having to input a new search query and run a second search for the second diagnosis. In some embodiments, the system may respond to such multiple selections by first stepping through the subcodes of the first selected code (e.g., subcodes S72.30 through S72.39, and the further subcodes of any selected from those subcodes), followed by the subcodes of the next selected code (e.g., subcodes S72.40 through S72.49, and the further subcodes of any selected from those subcodes), and so on.

In some embodiments, in addition to presenting the child codes of a selected parent code, one or more additional selectable items may also be presented corresponding to codes that are designated in the code set as being codes that should also be considered when using the selected code (e.g., because they commonly co-occur with the selected code). Such codes are referred to herein as “consider-also” codes. For example, the standard ICD databases promulgated by CMS include fields such as “code also,” “code first,” and “use additional code” notes under entries for certain codes, and some embodiments may present selectable items corresponding to codes in such consider-also fields in response to user selection of the main code with which those fields are associated. An example is the instruction in ICD-10-CM to use additional codes to report tobacco use when documenting a diagnosis of asthma. In some embodiments, in response to the user's selection of an item corresponding to an asthma diagnosis code, the system may present selectable items corresponding to tobacco use diagnosis codes, either simultaneously with or separately from (e.g., in sequence after) any subcodes of the selected asthma code.

Code search techniques described herein may be used in various different implementations and workflows in various different embodiments. In some embodiments, the code search tool may be implemented as a standalone software application, while in other embodiments, it may be integrated with one or more other applications, such as an electronic medical record (EMR) database system, a clinician documentation (e.g., medical report dictation) system, a medical coding system, or any other suitable system. Embodiments described herein may be used by clinicians documenting patient encounters, by coders assigning codes to received documentation, and/or by any other suitable personnel. Depending on the context in which the code search tool is used, in some embodiments the tool may present, output, and/or track selections of symbolic (e.g., numerical/alphanumerical) codes, while other embodiments may expose only descriptive names or other descriptive text corresponding to the symbolic codes which may not be presented to some or all users, such as clinicians. For example, in some embodiments, the selectable items presented to clinicians may only include the descriptive names of ICD codes rather than the codes themselves (e.g., “Diabetes mellitus” instead of ICD-9-CM code “250”), such that the clinician may focus primarily on the substantive documentation as opposed to the symbolic coding. In some such embodiments, the symbolic codes corresponding to the descriptive items selected by the user may optionally be tracked and transmitted to other applications, such as billing processes. On the other hand, descriptive selections, in some embodiments, may be output as simple text, e.g., to a recipient application (e.g., an EMR, documentation system, etc.) and/or to an operating system clipboard for pasting into another application (e.g., a word processing application).

It should be appreciated that the foregoing description is by way of example only, and some embodiments are not limited to providing any or all of the above-described functionality, although some embodiments may provide some or all of the functionality described herein.

The functionality described herein can be implemented in any of numerous ways, and is not limited to any particular implementation techniques. Thus, while examples of specific implementation techniques are described below, it should be appreciated that the examples are provided merely for purposes of illustration, and that other implementations are possible.

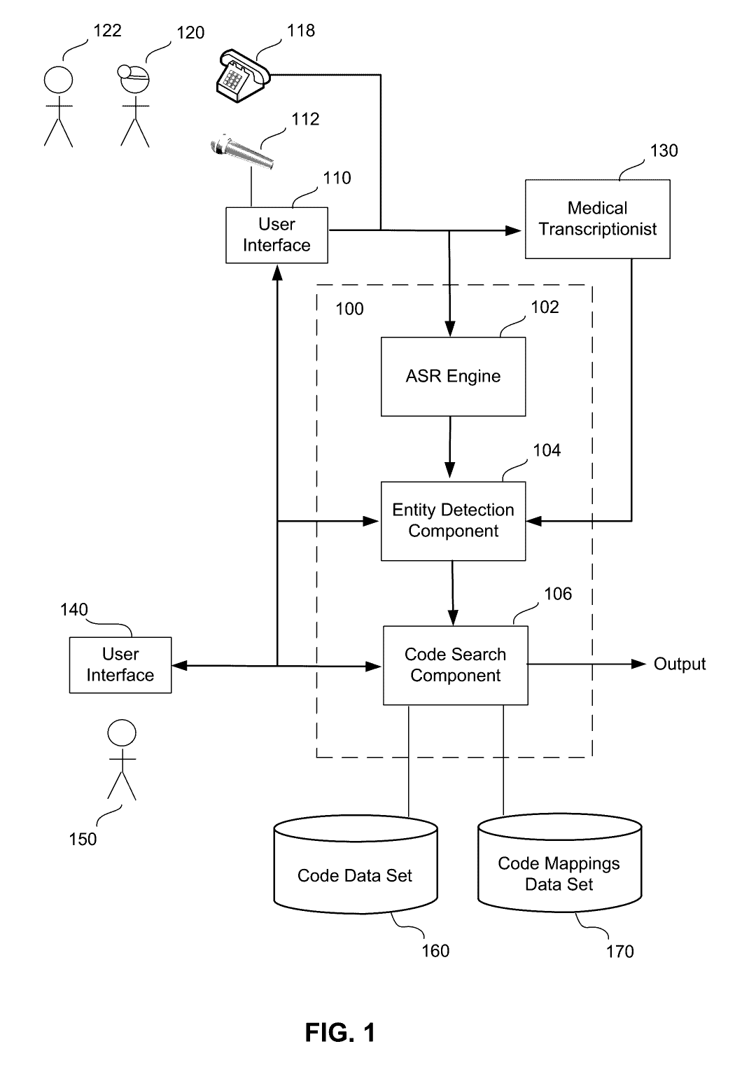

One illustrative application for techniques described herein is for use in a system for enhancing medical documentation processes. An exemplary operating environment for such a system is illustrated in FIG. 1. The exemplary operating environment includes a medical documentation system 100, which may be implemented in any suitable form, as embodiments are not limited in this respect. For example, system 100 may be implemented as a single stand-alone machine, or may be implemented by multiple distributed machines that share processing tasks in any suitable manner. System 100 may be implemented as one or more computers; an example of a suitable computer is described below. In some embodiments, system 100 may include one or more tangible, non-transitory processor-readable storage devices storing processor-executable instructions, and one or more processors that execute the processor-executable instructions to perform the functions described herein. The storage devices may be implemented as computer-readable storage media (i.e., tangible, non-transitory computer-readable media) encoded with the processor-executable instructions; examples of suitable computer-readable storage media are discussed below.

As depicted, exemplary system 100 includes an ASR engine 102, an entity detection component 104, and a code search component 106. Each of these processing components of system 100 may be implemented in software, hardware, or a combination of software and hardware. Components implemented in software may comprise sets of processor-executable instructions that may be executed by the one or more processors of system 100 to perform the functionality described herein. Each of ASR engine 102, entity detection component 104, and code search component 106 may be implemented as a separate component of system 100 (e.g., implemented by hardware and/or software code that is independent and performs dedicated functions of the component), or any combination of these components may be integrated into a single component or a set of distributed components (e.g., hardware and/or software code that performs two or more of the functions described herein may be integrated, the performance of shared code may be distributed among two or more hardware modules, etc.). In addition, any one of ASR engine 102, entity detection component 104, and code search component 106 may be implemented as a set of multiple software and/or hardware components. Although the example operating environment of FIG. 1 depicts ASR engine 102, entity detection component 104, and code search component 106 implemented together on system 100, this is only an example; in other examples, any or all of the components may be implemented on one or more separate machines, or parts of any or all of the components may be implemented across multiple machines in a distributed fashion and/or in various combinations. It should be understood that any such component depicted in FIG. 1 is not limited to any particular software and/or hardware implementation and/or configuration. In addition, not all embodiments may include or make use of all of the exemplary components illustrated in FIG. 1. For example, some embodiments may omit functionality of ASR engine 102 and/or entity detection component 104, as described further below.

In the exemplary operating environment illustrated in FIG. 1, user interface 110 is presented to a clinician 120, who may be a physician, a physician's aide, a nurse, or any other personnel involved in the evaluation and/or treatment of a patient 122 in a clinical setting. During the course of a clinical encounter with patient 122, or at some point thereafter, clinician 120 may document the patient encounter. Such a patient encounter may include any interaction between clinician 120 and patient 122 in a clinical evaluation and/or treatment setting, including, but not limited to, an office visit, an interaction during hospital rounds, an outpatient or inpatient procedure (surgical or non-surgical), a follow-up evaluation, a visit for laboratory or radiology testing, etc. For purposes of the present disclosure, documenting a patient encounter may also include documenting findings from clinical functions that do not involve or require personal interaction with the patient, such as laboratory results, radiology exams, other types of tests, etc.

One method that clinician 120 may use to document the patient encounter may be to enter medical facts that can be ascertained from the patient encounter into user interface 110 as discrete data items. In some embodiments, as described further below, the discrete medical facts may be in the form of standard medical codes, such as diagnosis and/or procedure codes, and/or in the form of textual labels corresponding to such codes. The set of medical facts, once entered, may be incorporated in some embodiments into an electronic medical record (EMR) for the patient, incorporated into other documentation of the patient encounter, forwarded to a billing process, and/or used in any other suitable way. In some embodiments, clinician 120 may be assisted in identifying the appropriate medical facts to document by code search component 106, exemplary functions of which are described below.

Another method that may be used by clinician 120 to document the patient encounter is to provide a free-form narration (e.g., a narrative report, a “physician's note,” etc.) of the patient encounter. A free-form narration of the patient encounter may be provided by clinician 120 in any of various ways. One way may be to manually enter the free-form narration in textual form into user interface 110, e.g., using a keyboard. In this respect, the one or more processors of system 100 and/or of a client device in communication with system 100 may in some embodiments be programmed to present a user interface including a text editor/word processor to clinician 120. Such a text editor/word processor may be implemented in any suitable way, as embodiments are not limited in this respect.

Another way to provide a free-form narration of the patient encounter may be to verbally speak a dictation of the patient encounter. Such a spoken dictation may be provided in any suitable way, as embodiments are not limited in this respect. As illustrated in FIG. 1, one way that clinician 120 may provide a spoken dictation of the free-form narration may be to speak the dictation into a microphone 112 providing input (e.g., via a direct wired connection, a direct wireless connection, or via a connection through an intermediate device) to user interface 110. An audio recording of the spoken dictation may then be stored in any suitable data format, and transmitted to system 100 and/or to medical transcriptionist 130. Another way that clinician 120 may provide the spoken dictation may be to speak into a telephone 118, from which an audio signal may be transmitted to be recorded at system 100, at the site of medical transcriptionist 130, or at any other suitable location. Alternatively, the audio signal may be recorded in any suitable data format at an intermediate facility, and the audio data may then be relayed to system 100 and/or to medical transcriptionist 130.

In some embodiments, medical transcriptionist 130 may receive the audio recording of the dictation provided by clinician 120, and may transcribe it into a textual representation of the free-form narration (e.g., into a text narrative). Medical transcriptionist 130 may be any human who listens to the audio dictation and writes or types what was spoken into a text document. In some embodiments, medical transcriptionist 130 may be specifically trained in the field of medical transcription, and may be well-versed in medical terminology. In some embodiments, medical transcriptionist 130 may transcribe exactly what she hears in the audio dictation, while in other embodiments, medical transcriptionist 130 may add formatting to the text transcription to comply with generally accepted medical document standards. When medical transcriptionist 130 has completed the transcription of the free-form narration into a textual representation, the resulting text narrative may in some embodiments be transmitted to system 100 or any other suitable location (e.g., to a storage location accessible to system 100). Specifically, in some embodiments the text narrative may be received from medical transcriptionist 130 by entity detection component 104 within system 100, exemplary functionality of which is described below. Alternatively or additionally, in another exemplary data flow the text narrative produced by medical transcriptionist 130 may be sent to a reviewer such as clinician 120 (e.g., at user interface 110) or another user 150 such as a coder (e.g., at user interface 140).

In some other embodiments, the audio recording of the spoken dictation may be received, at system 100 or any other suitable location, by automatic speech recognition (ASR) engine 102. In some embodiments, ASR engine 102 may then process the audio recording to determine what was spoken. Such processing may involve any suitable speech recognition technique(s), as embodiments are not limited in this respect. In some embodiments, the audio recording may be automatically converted to a textual representation, while in other embodiments, words identified directly from the audio recording may be represented in a data format other than text, or abstract concepts may be identified instead of words. Examples of further processing are described below with reference to a text narrative that is a textual representation of the free-form narration; however, it should be appreciated that similar processing may be performed on other representations of the free-form narration as discussed above. When a textual representation is produced, in some embodiments it may be reviewed by a human (e.g., a transcriptionist) for accuracy, while in other embodiments the output of ASR engine 102 may be accepted as accurate without human review. Some embodiments are not limited to any particular method for transcribing audio data; an audio recording of a spoken dictation may be transcribed manually by a human transcriptionist, automatically by ASR, or semiautomatically by human editing of a draft transcription produced by ASR. Transcriptions produced by ASR engine 102 and/or by transcriptionist 130 may be encoded or otherwise represented as data in any suitable form, as embodiments are not limited in this respect.

In some embodiments, a text narrative, whether produced by ASR engine 102 (and optionally verified or not by a human), produced by medical transcriptionist 130, directly entered in textual form through user interface 110, or produced in any other way, may be processed by entity detection component 104 to detect mentions of medical facts relevant to coding the patient encounter. Entity detection component 104 may be configured to detect such mentions in a text narrative, e.g., via execution of stored instructions by the one or more processors of system 100, in any suitable way. For example, some embodiments employing entity detection component 104 may utilize any of the entity detection and/or fact extraction techniques described in U.S. patent application Ser. No. 13/650,879, filed Oct. 12, 2012, entitled “Methods and Apparatus for Presenting Alternative Hypotheses for Medical Facts,” and/or in U.S. patent application Ser. No. 13/795,886, filed Mar. 12, 2013, entitled “Methods and Apparatus for Entity Detection.” The disclosures of both of these patent applications are hereby incorporated by reference in their entireties. In some embodiments, entity detection component 104 may be configured to detect mentions of relevant entities (e.g., medical facts) such as diagnoses and/or procedures, possibly among other types of entities, within a clinician's narrative documentation of a patient encounter. In some embodiments, entity detection component 104 may be specifically programmed to detect mentions of entities of types for which symbolic coding systems are available and to be applied, while in other embodiments, entity detection component 104 may detect a larger set of entity types, and may identify a subset of those entities as being subject to symbolic coding. While the examples illustrated herein focus on diagnosis and procedure coding, embodiments are not limited to these examples. Techniques described herein may be used for coding and/or for improving supporting documentation for coding any suitable type of medical fact for which a suitable code set is or may become available, such as diagnoses, procedures, medications, allergies, body sites, medical devices, and so on.

In some embodiments, when entity detection component 104 detects a mention in a clinician's narrative of an entity of a type subject to medical coding, entity detection component 104 may extract the portion of the narrative text corresponding to the entity mention, and may submit the extracted text to code search component 106 as an input search query to retrieve one or more matching codes. In this sense, an automated component such as entity detection component 104 (e.g., a software application or other computer component) may in some embodiments function as a “user” submitting an input search query to code search component 106. In some embodiments, entity detection component 104 may be programmed to detect mentions of entities of particular types in a set designated as being subject to coding. For example, in some embodiments, entity detection component 104 may be configured to detect mentions of diagnosis and/or procedure entities, and to submit the text corresponding to those mentions as input search queries to code search component 106. For instance, in processing a clinician's narrative containing the text “diabetes,” entity detection component 104 may recognize that text token as a mention of a diagnosis entity, and may extract and submit “diabetes” as an input search query to code search component 106.

In some embodiments, an input search query submitted to code search component 106 may begin a process whereby a user may be prompted through steps of selecting one or more specific medical codes or corresponding descriptive text to document the entity (e.g., diagnosis, procedure, etc.) detected in the narrative documentation. For example, in some embodiments, while clinician 120 is entering a narrative report, or after the narrative has been entered, entity detection component 104 may detect one or more codable entity mentions and may submit the corresponding text as an input search query to code search component 106, which may retrieve one or more matching codes relevant to the search query and present corresponding selectable items to clinician 120 to elicit the clinician's identification of the most specific code that can be applied to the patient's diagnosis, procedure, etc. In another example, detected mentions of codable entities in a narrative report authored by clinician 120 may be submitted as input search queries to code search component 106, which may present selectable items corresponding to relevant codes to another user 150 (e.g., a medical coder or other user reviewing the documentation of the patient encounter) to elicit that user's identification of the most specific codes to apply.

However, in some other embodiments, entity detection component 104 may not be involved, and clinician 120 and/or other user 150 may input search queries directly to code search component 106 via one or more electronic user interfaces, such as user interface (UI) 110 and/or UI 140. For example, in some embodiments, code search component 106 may be integrated into an EMR into which clinician 120 may enter patient data such as a patient's diagnoses, procedures, and/or other medical facts, and/or in a medical documentation system including, e.g., a word processing application into which clinician 120 may enter a narrative report documenting the patient encounter. Similarly, in some embodiments, code search component 106 may be integrated into a system used by a medical coder or other user 150 reviewing documentation of the patient encounter. In any of these embodiments, functions of the integrated code search tool may be called in any suitable way (e.g., by highlighting text in the documentation and activating a button or otherwise entering a command to invoke the code search tool and submit the highlighted text as a search query, or by directly entering the search query into an input field for the integrated code search tool, embedded in or callable from an interface of the EMR or other connected application) to find medical codes and/or corresponding descriptive text for codable items in the documentation. In other embodiments, as mentioned above, code search component 106 may be implemented as a non-integrated application which may be operated independently of any other EMR, documentation system, or other application. In some embodiments, clinician 120 and/or other user 150 may enter search queries into a standalone code search component in any suitable way, such as via keyboard text, machine-recognized speech, or copied-and-pasted text from another application. Likewise, selected codes and/or text output from code search component 106 in some embodiments may be output directly to another integrated or designated application (e.g., an EMR, a narrative report in a word processing application, a coding/billing process, etc.), while in other embodiments output text and/or codes may be manually copied and transferred to a desired destination.

For purposes of illustration, exemplary functionality of one or more code search tools such as code search component 106 in accordance with some embodiments is described below with reference to exemplary user interface screen displays. Such displays may be presented, for example, to one or more clinicians 120 (e.g., via user interface 110) and/or other users 150 (e.g., via user interface 140) by code search component 106, which may receive input search queries and selections from the user(s) and provide responsive selectable items and output via any suitable electronic user interface. It should be appreciated, however, that the following description and the accompanying figures are provided merely for purposes of example, and that embodiments are not limited to any exemplary user interface layout or specific content.

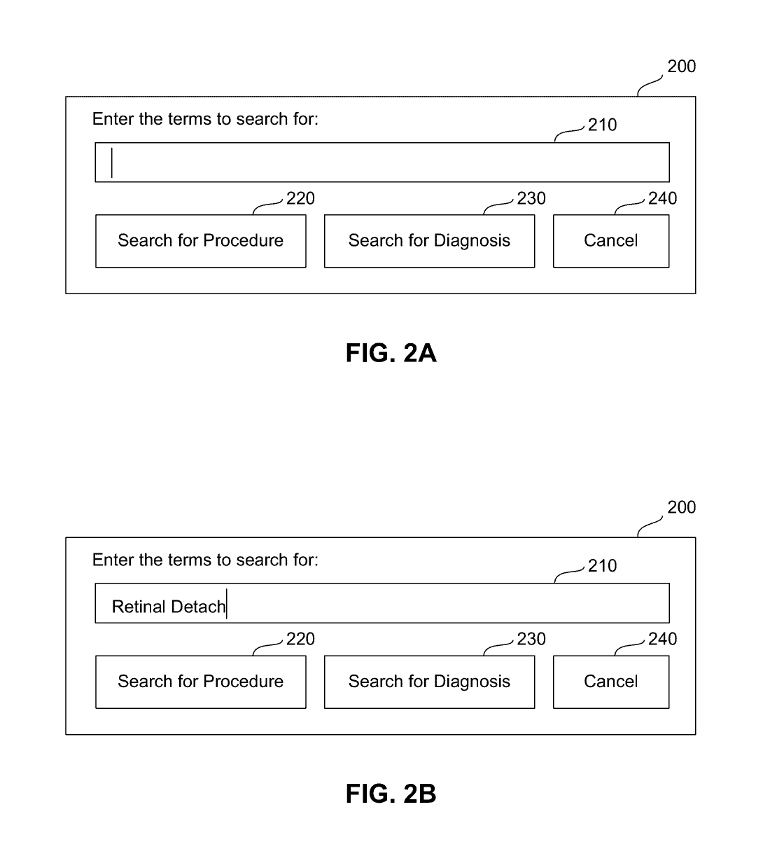

Illustrated in FIG. 2A is an exemplary user interface (UI) screen 200 that may be provided in some embodiments for allowing a user to input a search query into input field 210. This may be done in any suitable way. For example, in some embodiments, a user may operate a text input device such as a keyboard or a touch screen to input a search query as text into input field 210. In another example, the user may speak an input query, which may be converted to machine-understandable form by automatic speech recognition. Thus, it should be appreciated that in some embodiments, functionality of ASR engine 102, or another speech recognition device or application not shown in FIG. 1, may be utilized to supply input data and/or commands to code search component 106, instead of or in addition to converting dictated reports to text. In some embodiments, all or any suitable portion(s) of the functionality described herein may be enabled for speech control, such that a user may provide input text, data and/or command (e.g., button) selections, and/or other control instructions via speech, e.g., partially or completely hands-free.

FIG. 2B illustrates an example where the user has input the search query “Retinal Detach” into input field 210 in UI screen 200. The user may then operate (e.g., by clicking, pressing, or otherwise selecting, manually or by speech command or other suitable control function) any of buttons 220, 230, and 240 provided in exemplary UI screen 200 for controlling subsequent action by the system. For example, the user may select “Search for Procedure” option 220 to search for medical procedure codes relevant to the search query “Retinal Detach,” or may select “Search for Diagnosis” option 230 to search for medical diagnosis codes relevant to the search query. Exemplary UI screen 200 also provides a “Cancel” option 240 for if the user wishes to abort inputting the search query.

In some embodiments, when a user inputs a search query and directs the system to perform a search, the query may be applied to one or more code data sets 160 accessible to code search component 106, to retrieve one or more matching medical codes. In some embodiments, code data set 160 may include diagnosis and/or procedure codes; however, some embodiments are not limited in this respect, and any suitable types of codes for which one or more hierarchical code sets are available may be used in some embodiments. In some particular embodiments, code data set 160 may include ICD-10 codes, such as ICD-10 diagnosis and/or procedure codes. In some embodiments, user selection of “Search for Procedure” option 220 may cause execution of a search of ICD-10-PCS procedure codes, while user selection of “Search for Diagnosis” option 230 may cause execution of a search of ICD-10-CM diagnosis codes. In other exemplary embodiments, “Search for Diagnosis” may cause execution of a search of ICD-9-CM codes, while “Search for Procedure” may cause execution of a search of CPT codes. Those of skill in the art will appreciate that other configurations utilizing other code sets and/or other combinations of code sets are also possible.

A search of a code data set for matching codes relevant to a user's input search query may be performed in any suitable way using any suitable search technique(s), as embodiments are not limited in this respect. For example, in some embodiments, keywords in the input search query may be detected in the descriptive text accompanying the codes in the promulgated code set(s), and/or in the code set's index or any other suitable text fields in the code set, to identify codes matching the search query. In some embodiments, any suitable enhancements to keyword searching may be applied, some techniques for which are known, such as stemming, synonym expansion, clinical terminology normalization, etc. Furthermore, some embodiments may allow for a user to input a search query using terminology familiar from one code set, while retrieving search results including matching codes from another code set. In this respect, some embodiments may include a data set of code mappings 170 storing known equivalencies and/or other associations between codes in different code sets. For example, in some embodiments, code mappings data set 170 may include mappings between ICD-9 codes and their closest related codes in the ICD-10 code set. In some such embodiments, a user may input a search query using ICD-9 terminology, which may be keyword-matched to ICD-9 entries in code mappings data set 170, whose mappings to corresponding ICD-10 codes may then be followed to retrieve the matching ICD-10 codes relevant to the input search query. In some embodiments, keyword searches may be executed on multiple code sets, such as on both ICD-9 and ICD-10 data sets, as a matter of course; while in other embodiments, a user may designate which code set or version of a code set to use for keyword matching, which in some cases may be different from the code set used to return matching code results.

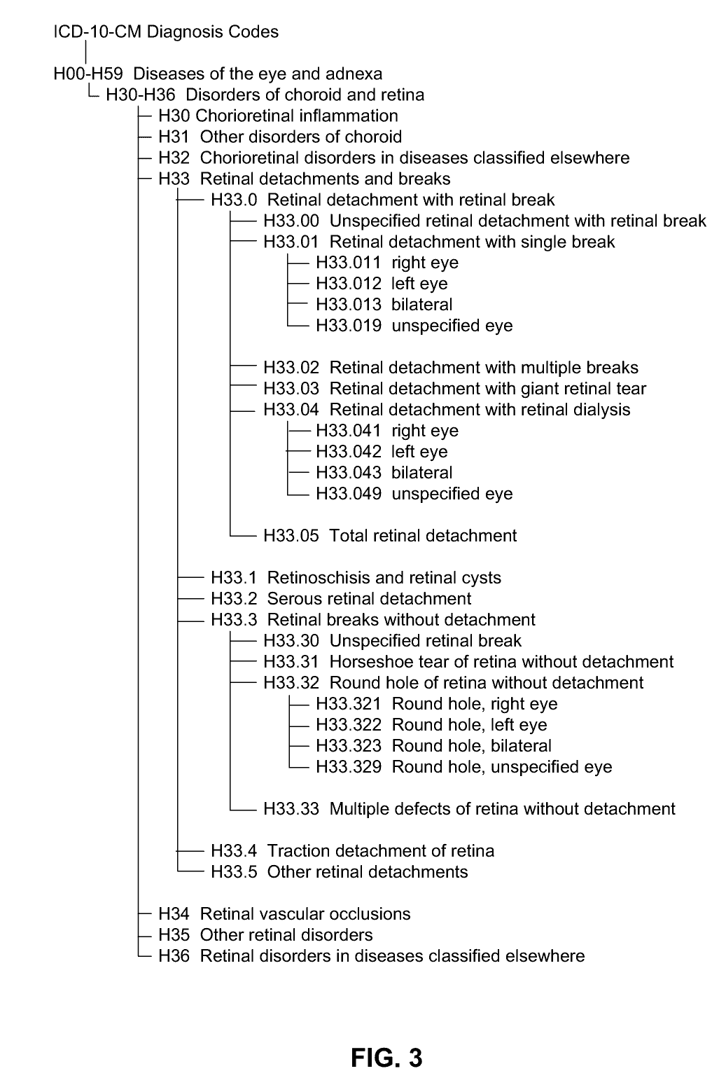

In some embodiments, upon retrieving a set of matching codes relevant to a user's input search query (e.g., by keyword matching in the descriptive names or other textual fields of the codes in the code set), code search component 106 may first present to the user only a subset of the matching codes that are not more specific subcodes of other retrieved matching codes. For example, if both a parent code and one or more child codes of the parent code have corresponding descriptive names that include keywords of the search query, in some embodiments only the parent code may be presented to the user in the first screen of search results. A specific example is illustrated in FIG. 3, which shows a partial expansion of the hierarchical ICD-10-CM diagnosis code set in tree form. (Although only some generic codes are expanded in FIG. 3 to show their child codes due to space considerations, it should be appreciated that other codes (e.g., H30-H32 and H34-H36, H33.1 and H33.2, H33.4 and H33.5, H33.00, H33.02 and H33.03, H33.05, H33.30 and H33.31, and H33.33) also have one or more levels of child codes that are not shown, and that H30-H36 is only one of many code blocks within H00-H59, which is only one of many chapters of the ICD-10-CM diagnosis codes.) Here, although the keywords “Retinal Detach” can be matched to generic code H33 as well as its child codes H33.0, H33.2, H33.3, H33.4 and H33.5 (and further children of those child codes), in some embodiments the child codes may not be presented to the user as search results until the parent code H33 (“Retinal detachments and breaks”) has been presented and selected by the user as partially satisfying the input search query.

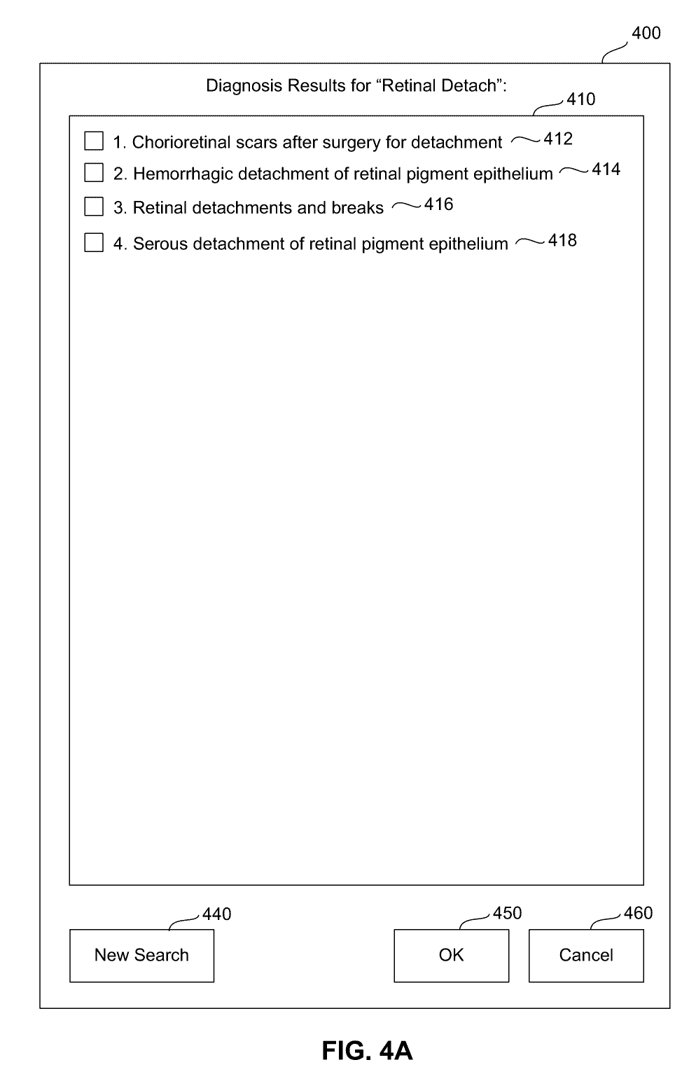

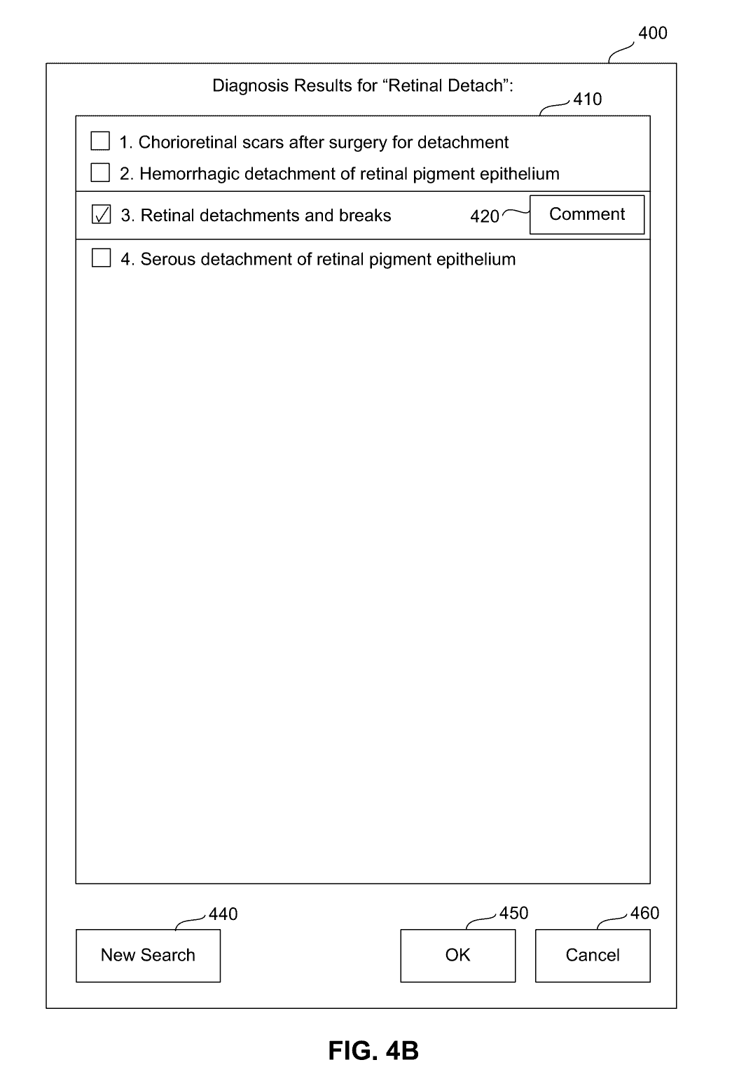

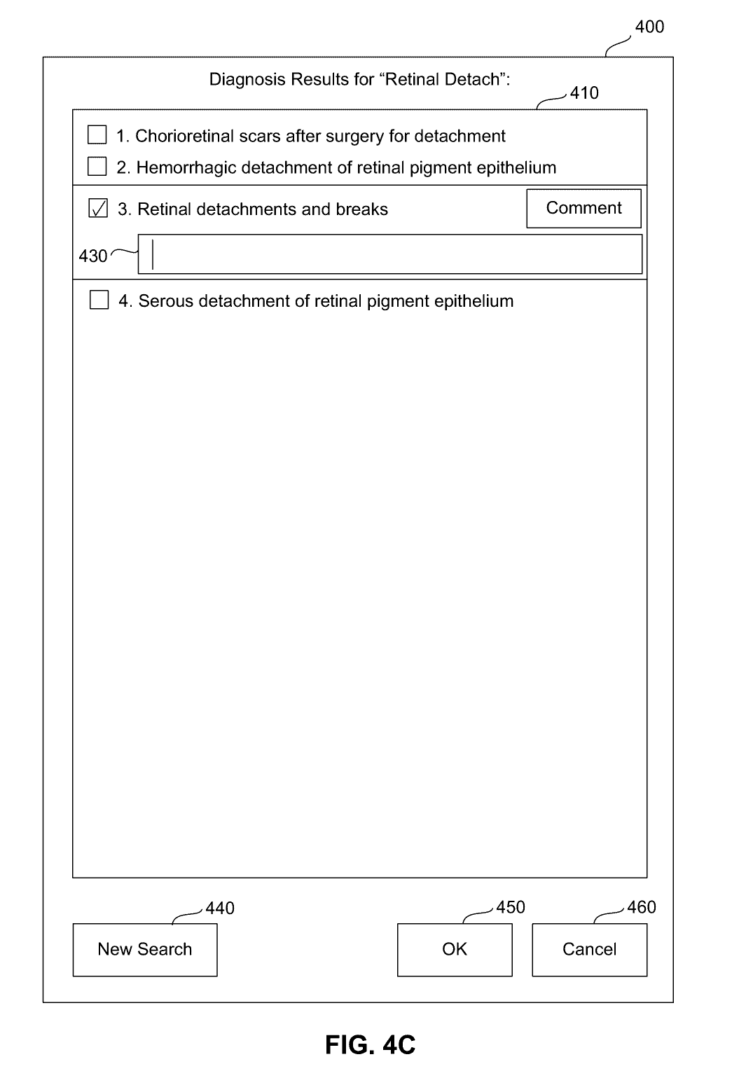

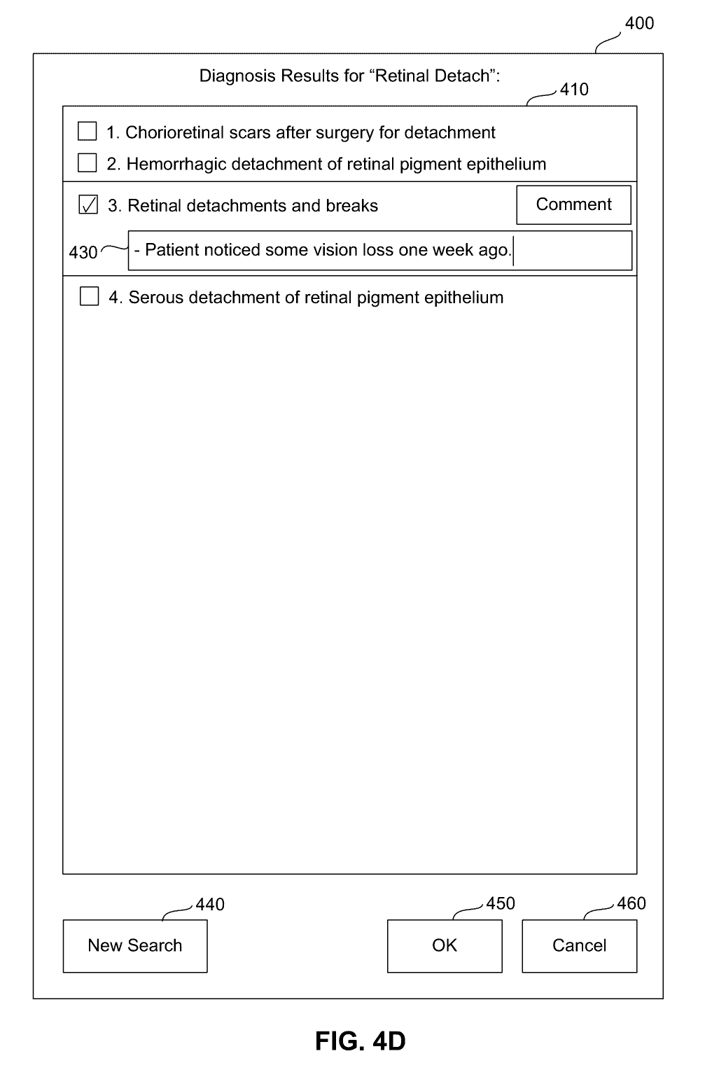

FIG. 4A illustrates an exemplary UI screen 400 that may be provided in some embodiments by code search component 106 to present initial search results relevant to the input search query “Retinal Detach” from FIG. 2B. As discussed above, in some embodiments the first screen of search results may present selectable items corresponding to only a subset of the retrieved matching codes that omits subcodes of other retrieved matching codes. In FIG. 4A, selectable items 412-418 are presented in results panel 410, each of the selectable items corresponding to one of the matching codes retrieved from the code set as being relevant to the input search query. As illustrated in this example, in some embodiments, the selectable items may include descriptive names of the matching codes, rather than the symbolic codes themselves. (However, in other embodiments, the symbolic codes may be presented, instead of or in addition to the descriptive names, and/or any other suitable identifying information may be included in the selectable items.) Here, “Retinal detachments and breaks” (H33), which is a code at the most generic code level in the ICD-10-CM hierarchy, is presented without any of its subcodes that were also keyword-matched to the input search query. Similarly, “Chorioretinal scars after surgery for detachment” (H59.81) is presented without its child codes; however, its parent code (H59.8) and grandparent code (H59) are not presented, because their descriptive names do not match the input search query. “Hemorrhagic detachment of retinal pigment epithelium” (H35.73) and “Serous detachment of retinal pigment epithelium” (H35.72) are sibling codes (so called because they share a common parent code) that are presented without their common parent code H35.7 (“Separation of retinal layers”), which also does not match the input search query.

In exemplary UI screen 400, when the user selects one of the presented selectable items (e.g., selectable item 416) in any suitable way (e.g., by click, touch, keyboard selection, speech selection, etc.), the item is visually distinguished as being selected (e.g., by highlighting, check mark, etc.), and a “Comment” option 420 is presented, as illustrated in FIG. 4B. Selecting “Comment” option 420 provides access to a comment input field 430 as illustrated in FIG. 4C, into which the user may provide a free-form text comment pertaining to the selected diagnosis. This may be useful, e.g., for the clinician to provide contextual information or other notes that he would like to be associated with the coded diagnosis in a report or EMR, etc. FIG. 4D gives an example of a comment entered in association with the selected generic diagnosis “Retinal detachments and breaks” (ICD-10-CM code H33). The user interface may provide any suitable input mechanism for entering comments, and may accept comments in any suitable form, such as direct text entry and/or machine-recognized speech, as embodiments are not limited in this respect. While some examples may include a comment input field within results panel 410, other examples may provide a separate comment input screen, window, etc., as illustrated further below.

Exemplary UI screen 400 further provides “New Search” button 440, “OK” button 450, and “Cancel” button 460. In this example, selecting “New Search” option 440 may cause the current search results to be discarded and the user to be returned to screen 200 for inputting a new search query. Selecting “Cancel” option 460 may cause the current search results to be discarded and the code search tool or application to exit. Selecting “OK” option 450 may cause the user's selection of one or more presented codes (represented in this case by their descriptive names) to be accepted as (partially) satisfying the input search query, and code search component 106 may then proceed to present more selectable items guiding the user to more specific codes for documenting the patient's diagnosis.

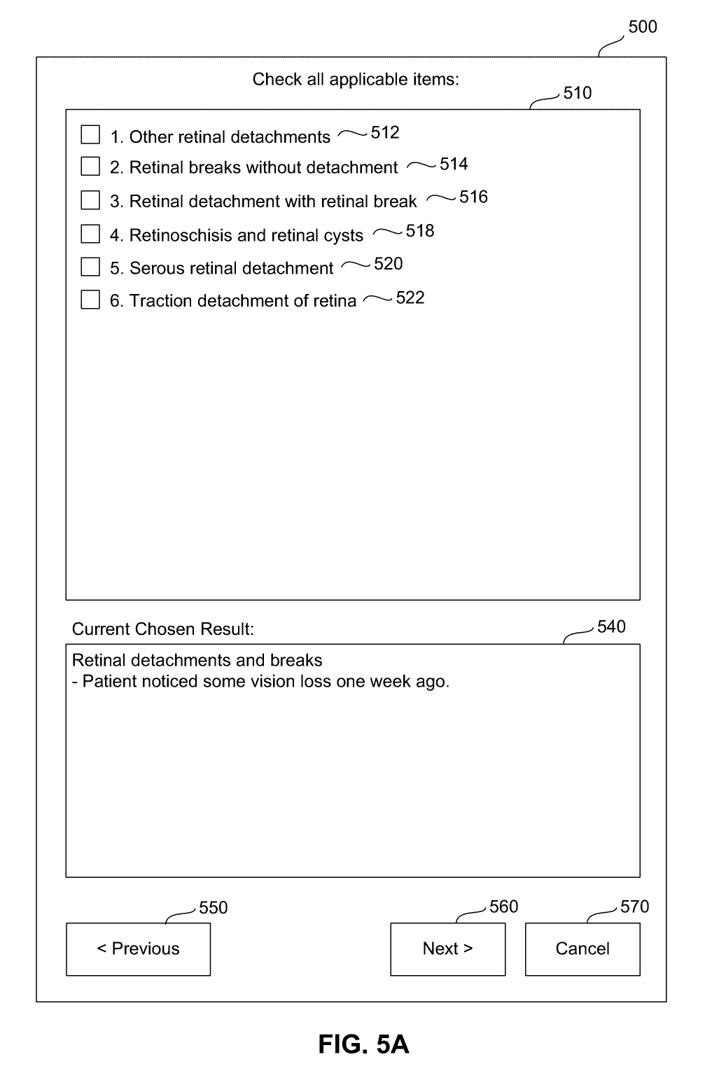

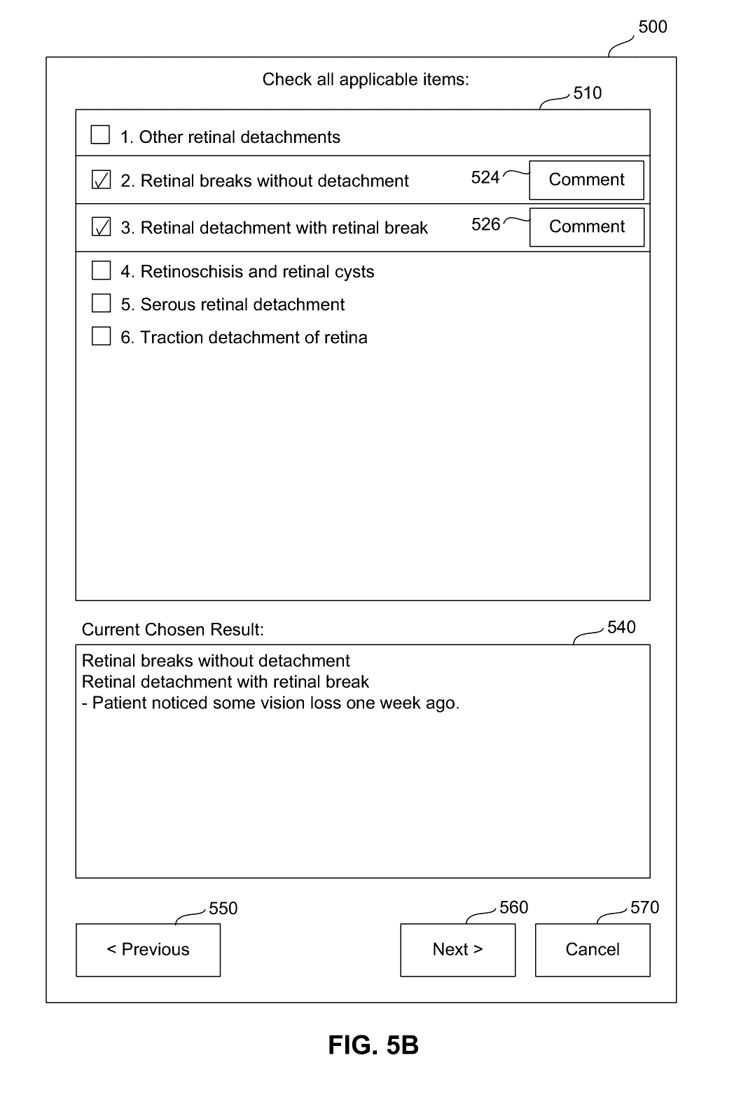

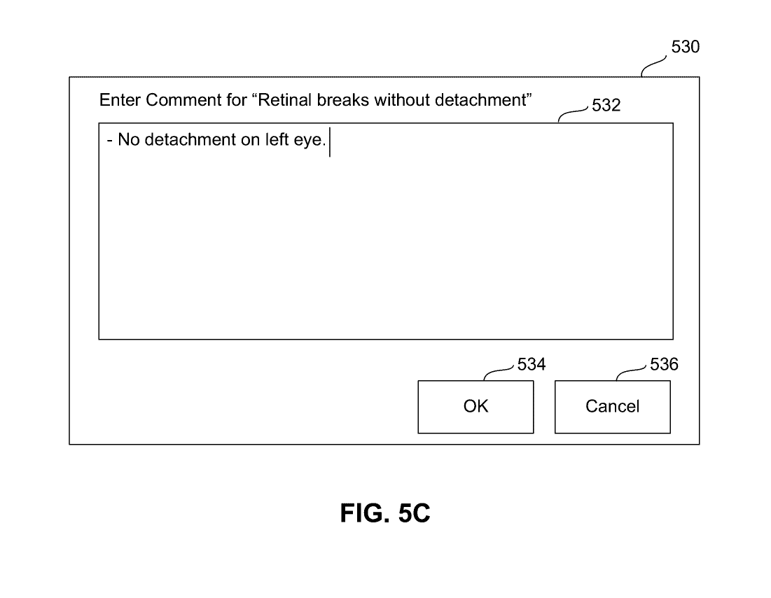

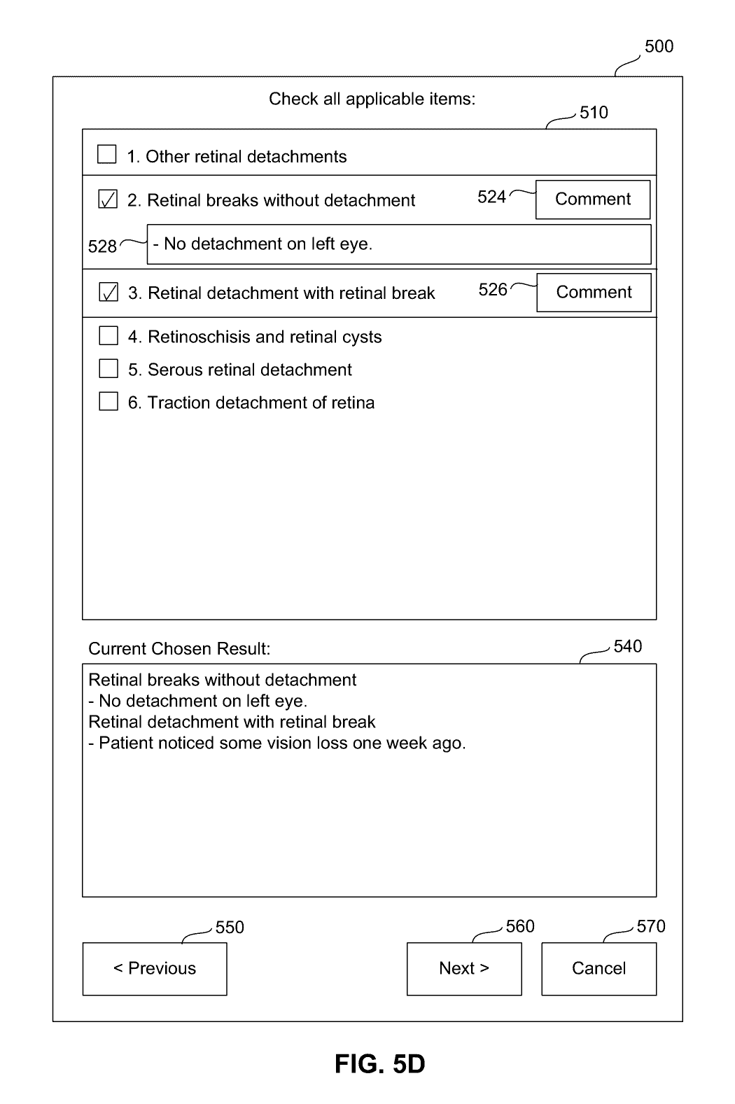

FIG. 5A illustrates an exemplary next UI screen 500 that may be provided in response to the user's selection of “OK” option 450 after selecting “Retinal detachments and breaks” in screen 400. Screen 500 includes an output panel 540 in which information is output corresponding to the codes selected by the user in the previous screen as satisfying (at least partially) the input search query. In this example, the output information includes the descriptive name of selected code H33, “Retinal detachments and breaks;” however, in other examples, the output information may include other items such as the symbolic code itself, instead of or in addition to the descriptive name. In some embodiments, the description may be displayed as output text, while the symbolic code may be tracked without visual presentation, for use in later processing. Also included in exemplary output panel 540 is the text comment entered by the user in the preceding screen. In some embodiments, such comments may be included in the output of code search component 106, with some indication of their association with the specific codes for which they were entered. In this example, the comment entered for “Retinal detachments and breaks” appears in the output text in proximity to the descriptive name of the selected code (e.g., just below the code name).

In some embodiments, in response to the user selecting an initial generic code item as (partially) satisfying the input search query, code search component 106 may then present one or more additional selectable items corresponding to the child nodes of the selected code in the code set hierarchy. In the example of FIG. 5A, having received the user's selection indicating that the generic “Retinal detachments and breaks” partially satisfies the input search query for the patient's diagnosis, code search component 106 now presents in results panel 510 selectable items 512-522 corresponding to codes H33.0 through H33.5 (i.e., the child codes of parent code H33). As indicated by the exemplary instruction to “Check all applicable items,” the user in this example is permitted to select any number of the presented selectable items that the user believes to be applicable in diagnosing the patient. Thus, in some embodiments, when the user is presented with selectable items corresponding to retrieved codes matching an input search query, and the user makes a selection of the code(s) that satisfy the query, the user may be permitted to include in the selection more than one selectable item corresponding to codes at the same level of hierarchy in the code set. In the example of FIG. 5A, the user may concurrently select multiple codes from the level in the ICD-10-CM hierarchy that is specified by a single digit to the right of the decimal point in the symbolic code. In some embodiments, the user may be permitted to select multiple sibling codes in the code set hierarchy, which share the same parent code. In the example of FIG. 5A, the codes are siblings with the common parent code H33 (“Retinal detachments and breaks”).

FIG. 5B shows an example in which the user has concurrently selected two codes, H33.3 (“Retinal breaks without detachment”) and H33.0 (“Retinal detachment with retinal break”). This might occur, for example, when the patient has multiple diagnoses to document and code; e.g., a retinal break without detachment in one eye, and a retinal detachment with retinal break in the other eye. The inventors have appreciated that when there are multiple applicable codes to include in documentation of a patient encounter, allowing for corresponding multiple selections in satisfaction of the same input search query (without requiring multiple search queries to be entered and multiple searches to be performed) may save valuable time for clinicians, coders, and/or other users, and may promote efficiency in the documentation process.

As illustrated in FIG. 5B, in some embodiments in response to receiving the user's selection of a (more specific) child code of a previously selected (more generic) code, the output information may be revised to replace the information corresponding to the previously selected generic code with information corresponding to the more specific selection. Thus, in FIG. 5B, the text “Retinal detachments and breaks” in output panel 540 has been replaced with both “Retinal breaks without detachment” and “Retinal detachment with retinal break,” corresponding to the user's new more specific selections. Similar to UI screen 400, UI screen 500 also populates with “Comment” buttons 524 and 526 in response to the user's selection of the corresponding code items. In FIG. 5C is illustrated a different example configuration for accepting input of a text comment, which may be triggered by user selection of a “Comment” button such as button 524 or button 526; namely, a separate screen 530 with a comment input field 532, “OK” button 534 for accepting the entered comment and returning to screen 500, and “Cancel” button 536 for returning to screen 500 without accepting any entered comment. FIG. 5D shows the result where the comment entered in connection with “Comment” button 524 (e.g., the comment entered in comment input screen 530 presented upon selection of “Comment” button 524) now appears in comment panel 528 in association with the corresponding code item “Retinal breaks without detachment,” and is additionally included in output panel 540 in proximity to (e.g., directly below) the code text “Retinal breaks without detachment.” Although not illustrated in FIG. 5D, if the user were to enter a comment in connection with “Comment” button 526 for “Retinal detachment with retinal break,” that comment could then be included in output panel 540 in proximity to its code text “Retinal detachment with retinal break.”

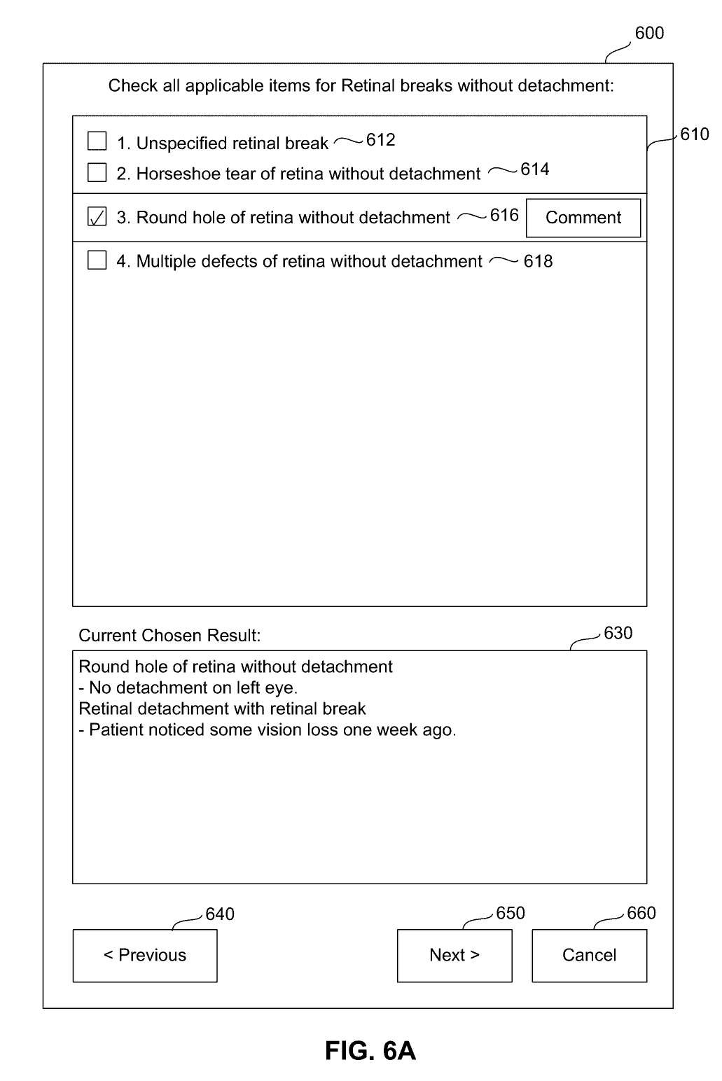

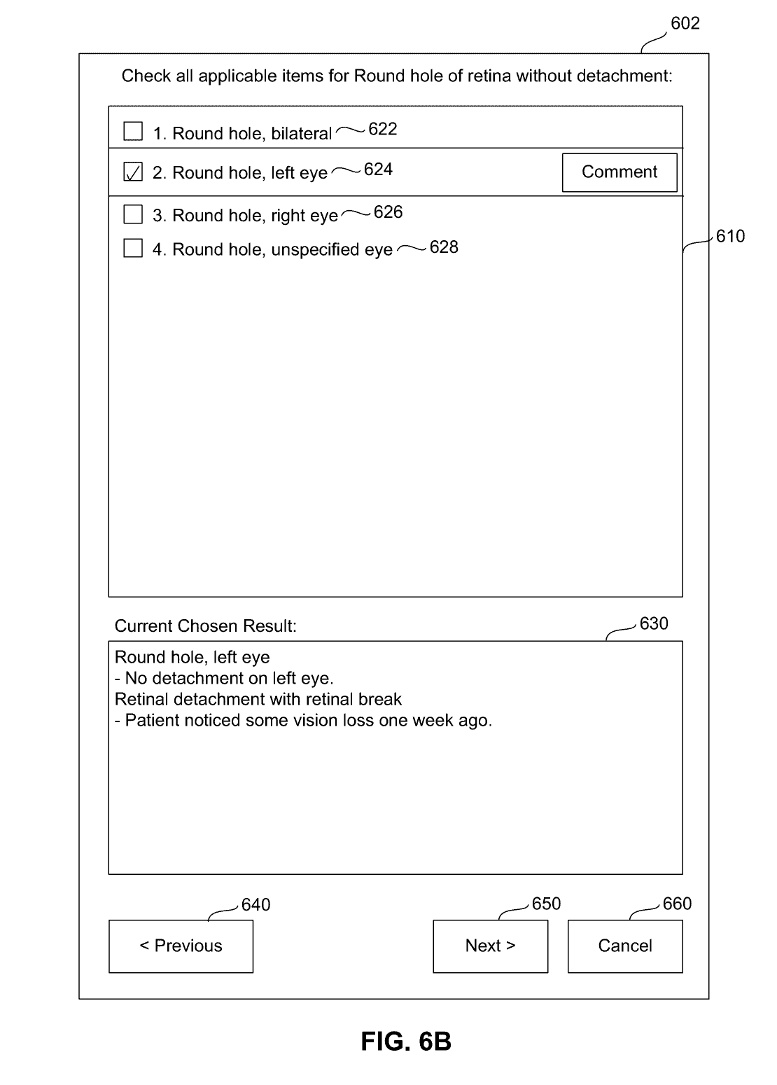

Exemplary UI screen 500 further includes “Previous” button 550 for going back to screen 400 to review and/or revise prior selections, “Cancel” button 570 for ending the search without saving any selections, and “Next” button 560 for accepting the current selections and proceeding to the next set of child codes. Where, as in this example, multiple codes were selected at the same level of hierarchy in satisfaction of the same search query, the presentation of child codes for the multiple selected codes may be performed in any suitable way and/or order. In some embodiments, the child codes for all selected codes may be presented together in the same screen, and the user may be permitted to select all that are applicable. However, in some embodiments, child codes may be presented sequentially—first the child codes of one selected code, followed by the child codes of another selected code. FIG. 6A illustrates an example UI screen 600 in which selectable items 612-618 corresponding to the child codes H33.30 through H33.33 of selected code H33.3 (“Retinal breaks without detachment”) are presented in results panel 610, and the user has selected H33.32 (“Round hole of retina without detachment”) as (further partially) satisfying the input search query. The more generic “Retinal breaks without detachment” is then replaced by the descriptive name of its subcode “Round hole of retina without detachment” in output panel 630. As shown in this example, in some embodiments when output information corresponding to a more generic code is replaced by output information corresponding to its more specific child code, any comment entered by the user in association with the more generic code may then remain in proximity to its more specific subcode in the output.

FIG. 6B illustrates an exemplary next UI screen 602, in which now selectable items 622-628 corresponding to the child codes H33.321 through H33.329 of selected code H33.32 (“Round hole of retina without detachment”) are presented in results panel 610, and the user has selected H33.322 (“Round hole, left eye”) as satisfying the input search query. The more generic “Round hole of retina without detachment” is then replaced by the descriptive name of its subcode “Round hole, left eye” in output panel 630. Exemplary UI screens 600 and 602 continue to provide “Previous” button 640, “Next” button 650, and “Cancel” button 660, whose functions are similar to the corresponding options in the previous screen. At this point, when the user selects “Next” option 650 in FIG. 6B, there are no further child nodes of selected code H33.322 in the ICD-10-CM hierarchy, and so the system may proceed to the next selected code for which child codes have not yet been presented; namely H33.0 (“Retinal detachment with retinal break”).

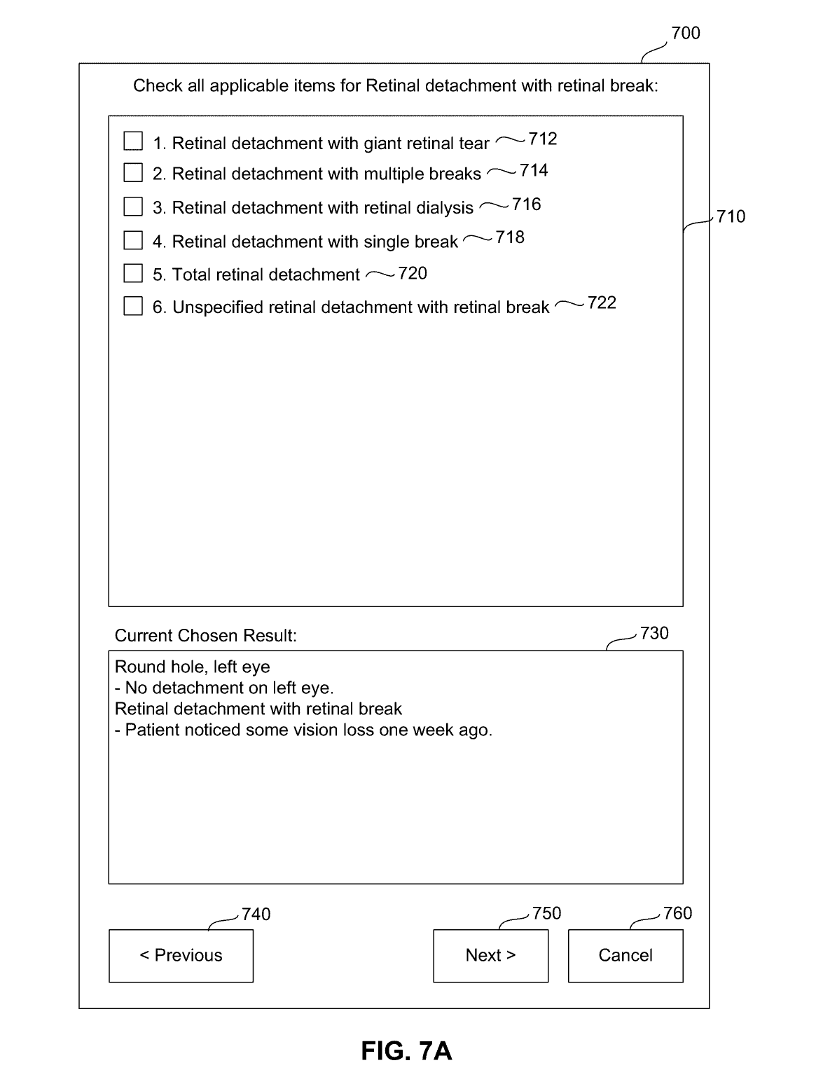

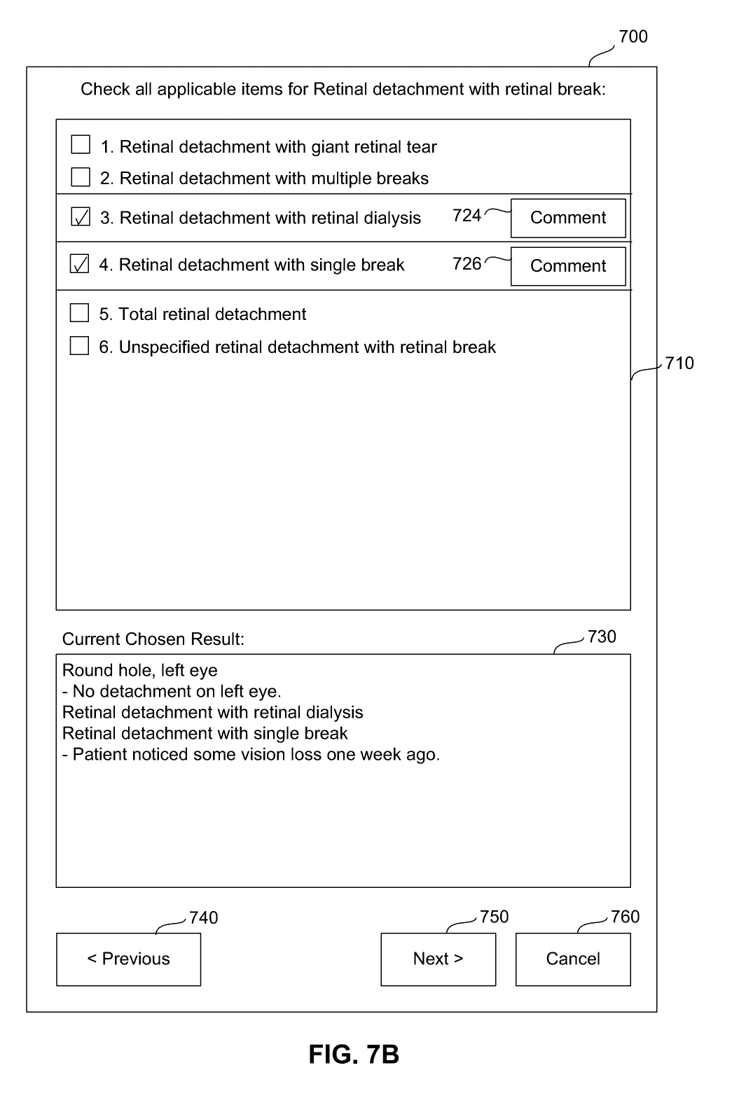

FIG. 7A illustrates an exemplary UI screen 700 in which selectable items 712-722 corresponding to the child codes H33.00 through H33.05 of selected code H33.0 are presented in results panel 710. Here again an example is depicted in FIG. 7B in which the user has selected more than one of the sibling codes; in this case, the patient exhibits both retinal dialysis and a single break in the right eye. The descriptive name of the parent code “Retinal detachment with retinal break” is replaced with both siblings “Retinal detachment with retinal dialysis” and “Retinal detachment with single break” in output panel 730. “Comment” buttons 724 and 726 are provided for the selected items, although in this example the user has not decided to exercise them. “Previous” button 740, “Next” button 750, and “Cancel” button 760 have similar functions as in preceding screens.

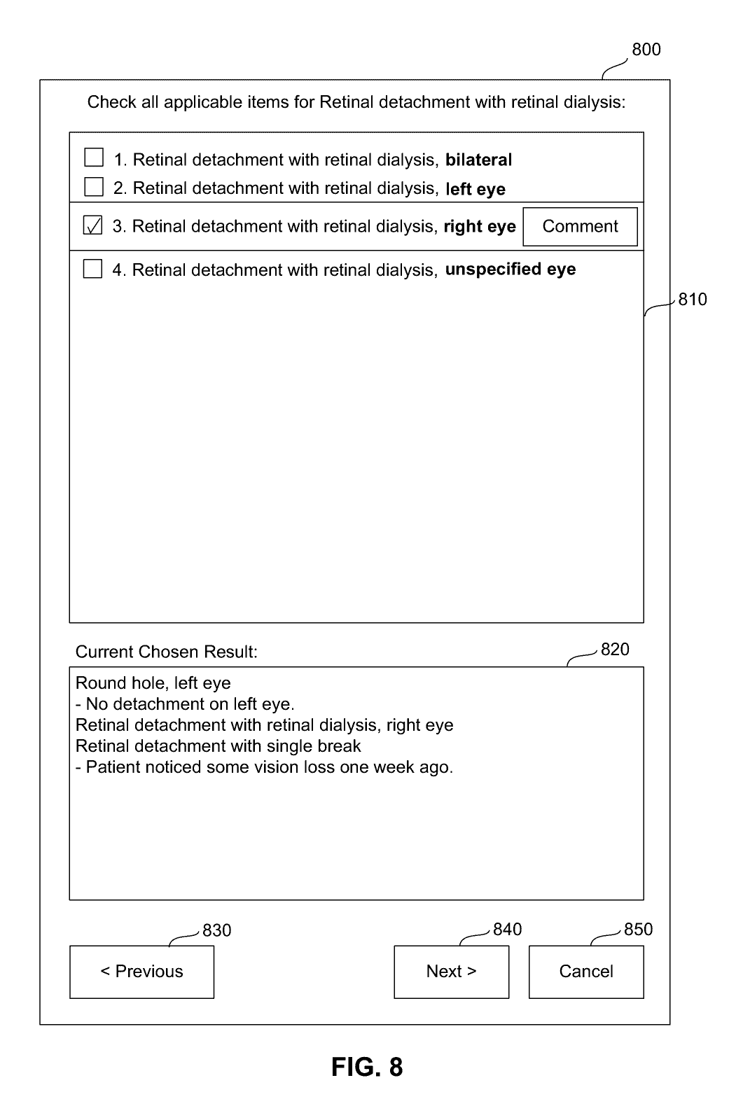

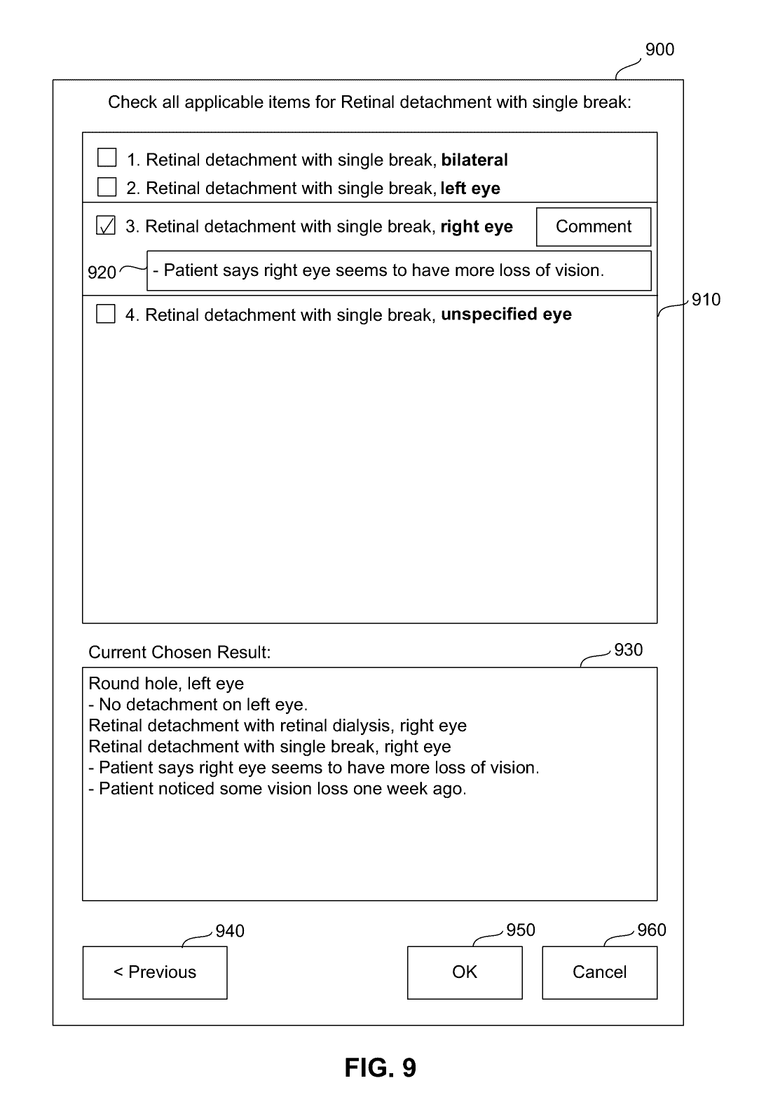

The example then continues tracing the hierarchy of the ICD-10-CM code set to sequentially present children of selected codes until each code is specified to the farthest possible level in the hierarchy. (However, in some embodiments, an option for the user to discontinue the sequential process and output information at an intermediate level of specificity may be provided.) FIG. 8 illustrates an exemplary UI screen 800 presenting child codes H33.041 through H33.049 of selected code H33.04 (“Retinal detachment with retinal dialysis”) in results panel 810, and FIG. 9 illustrates an exemplary UI screen 900 presenting child codes H33.011 through H33.019 of selected code H33.01 (“Retinal detachment with single break”) in results panel 910. As illustrated in these examples, some embodiments may provide a visual indication in the selectable items of parts of the descriptive text for code items that have not yet been considered, as distinguished from parts of the descriptive text corresponding to the generic category already selected. For example, the selectable items in FIG. 8 are presented with their differentiating text portions (“bilateral,” “left eye,” “right eye,” and “unspecified eye”) in bold, while the text corresponding to the parent code already selected (“Retinal detachment with retinal dialysis”) is colored differently in a manner that gives it less emphasis. In output panel 820 of screen 800, the more generic text “Retinal detachment with retinal dialysis” has been replaced by the more specific selection “Retinal detachment with retinal dialysis, right eye,” and in output panel 930 of screen 900, the more generic text “Retinal detachment with single break” has been replaced by the more specific selection “Retinal detachment with single break, right eye.” Additionally, the user has entered a free-form comment in association with “Retinal detachment with single break, right eye,” which appears both in comment panel 920 and in output panel 930 in proximity to the descriptive name of the associated code.

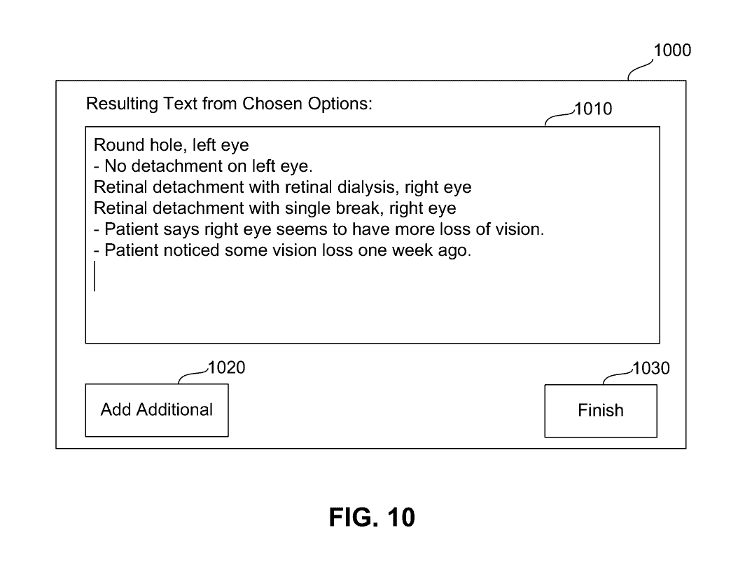

“Previous” buttons 830 and 940, “Cancel” buttons 850 and 960, and “Next” button 840 in FIGS. 8 and 9 have similar functions as in preceding screens. However, in exemplary UI screen 900, the “Next” button is replaced with “OK” button 950, indicating that no further child codes are remaining to be presented for codes selected in satisfaction of the current input search query. In some embodiments, code search component 106 may then output information corresponding to the selected codes; in this example, the output is performed in response to the user's activation of “OK” option 950. Information corresponding to the selected codes may be output in any suitable way and in any suitable form, such as in the form of the symbolic codes and/or text including descriptive names of codes, free-form comments, and/or any other suitable information connected to the selected codes. Some examples of types of output are described above. FIG. 10 illustrates another example, in which the text from output panel 930 is displayed in a finalizing output panel 1010 in a new UI screen 1000, where the user may select “Finish” option 1030 to copy the output text from panel 1010 to another location (e.g., to an EMR field, to a location in a narrative report, and/or to an application's or operating system's clipboard to be pasted into any suitable other location).

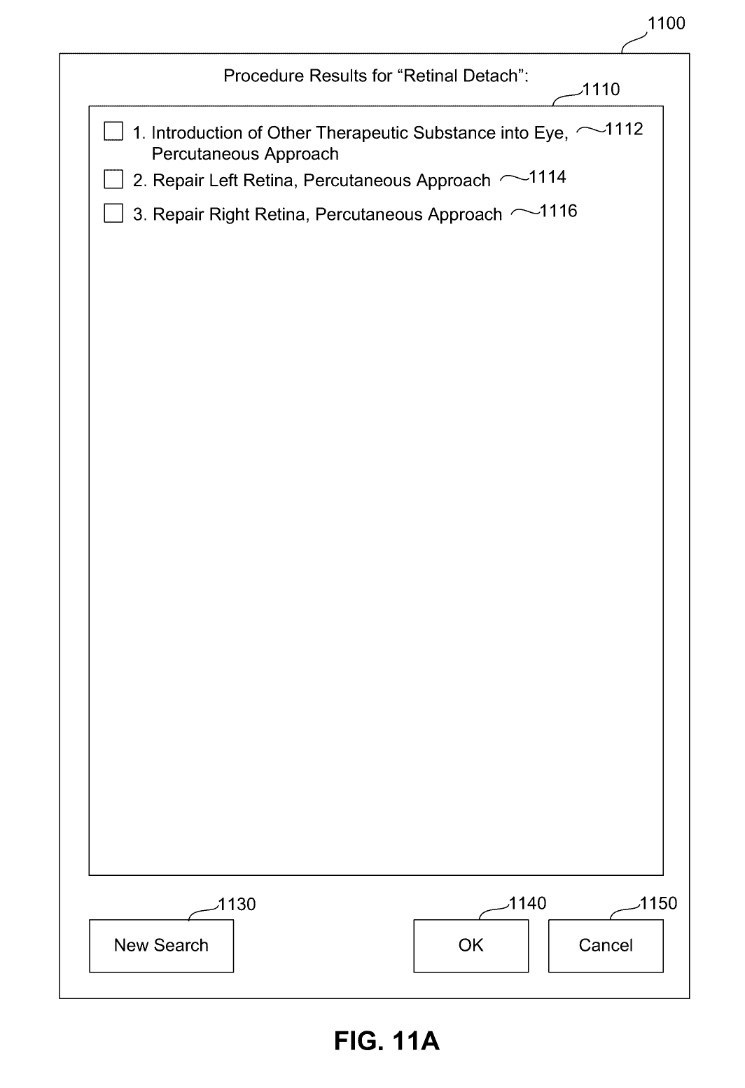

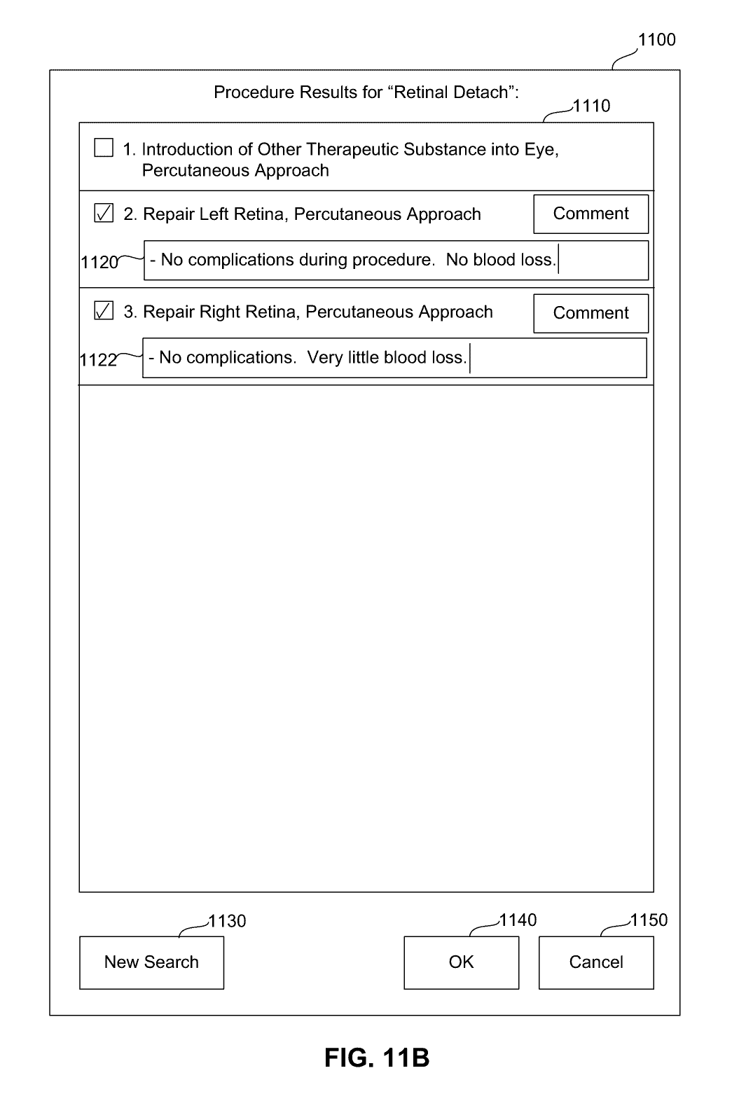

The example in FIG. 10 also provides an “Add Additional” option 1020, which the user may use to retain the current output information while launching a new search to append additional codes (and/or information such as descriptions representing the codes) to the output. FIG. 11A illustrates an example in which the user has selected “Add Additional” button 1020, returned to the search query screen 200, and selected the “Search for Procedure” option 220 using the same input search query, “Retinal Detach.” In this example, code search component 106 responds by matching the search query to codes in the ICD-10-PCS procedure code set, and the descriptive names of relevant matching codes are presented as selectable items 1112-1116 in results panel 1110 of exemplary UI screen 1100. As illustrated in the example of FIG. 11B, the user continues to be permitted to select multiple codes as satisfying the same input search query without having to perform multiple searches, and can add comments (e.g., comments 1120 and 1122) in association with selected codes. Where child codes of selected codes exist in the code set, in some embodiments those may be presented in subsequent screens, although not illustrated in this particular example. “New Search” button 1130, “OK” button 1140, and “Cancel” button 1150 have similar functions as the corresponding elements in FIG. 4.

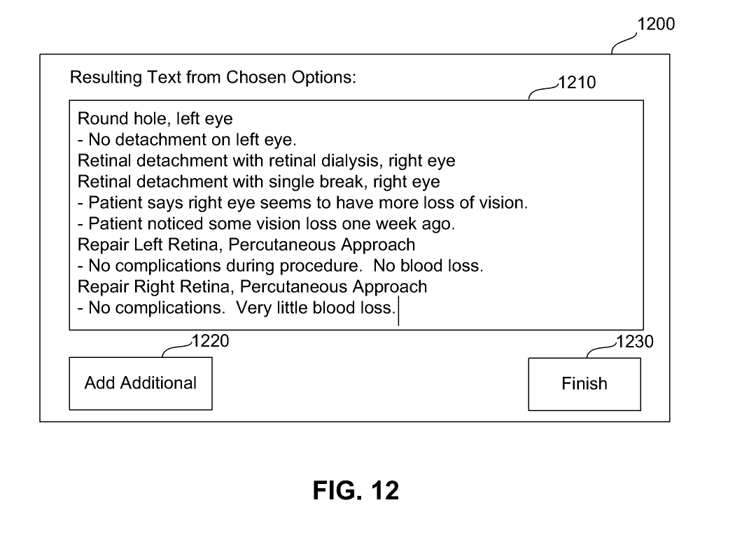

As illustrated in FIG. 12, at the conclusion of the additional search, the output information for the additional selected codes and any associated comments may be appended to the output information for the original search in finalizing output panel 1210 of UI screen 1200. The user may then select “Add Additional” option 1220 to execute one or more further searches (e.g., using different input search queries), or may select “Finish” option 1230 to complete the output of the assembled information from code search component 106. In some embodiments, the user may also be permitted to directly add text (e.g., by keyboard entry, dictation, or any other suitable method) to panel 1210 before finishing the output.

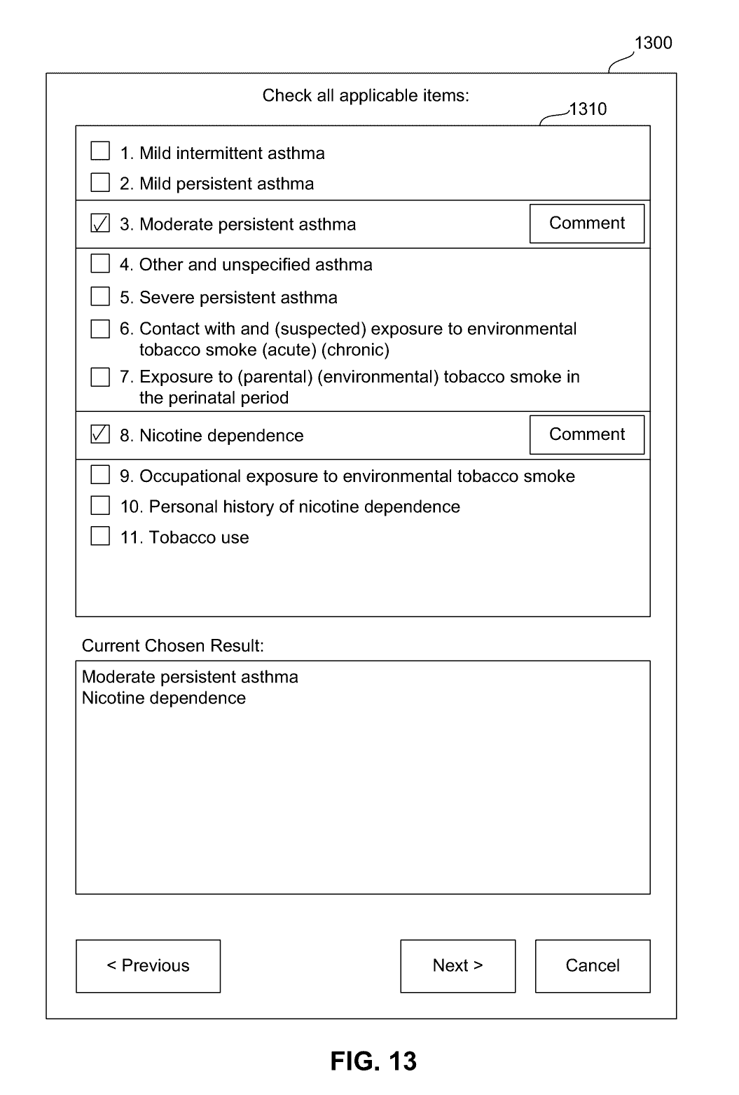

In some embodiments, as described above, in response to receiving the user's selection of a first generic code as (partially) satisfying an input search query, code search component 106 may present to the user any codes that are designated as consider- also codes for the selected code. These consider-also codes may not be child codes of the selected code, but in some embodiments may be presented in conjunction with the selected code's child codes, or independently. For instance, an example is illustrated in FIG. 13, which shows an exemplary UI screen 1300 displayed in response to the user's selection of generic code J45 (“Asthma”) as partially satisfying an input search query. In results panel 1310, child codes J45.2 through J45.9 of the selected code are presented (selectable items 1-5), as well as consider-also codes related to tobacco use/exposure (selectable items 6-11). In this example, these tobacco use/exposure codes are found in “use additional code” notes for “Asthma” code J45 in the ICD-10-CM code set. In some embodiments, consider-also codes such as the codes corresponding to selectable items 6-11 may be visually distinguished in results panel 1310 from other codes such as child codes in any suitable way, e.g., by coloring them differently, applying different highlighting, different font styles, etc. In some embodiments, the user may be permitted to select one or more consider-also codes concurrently with one or more other codes satisfying the input search query, without having to perform an additional search.

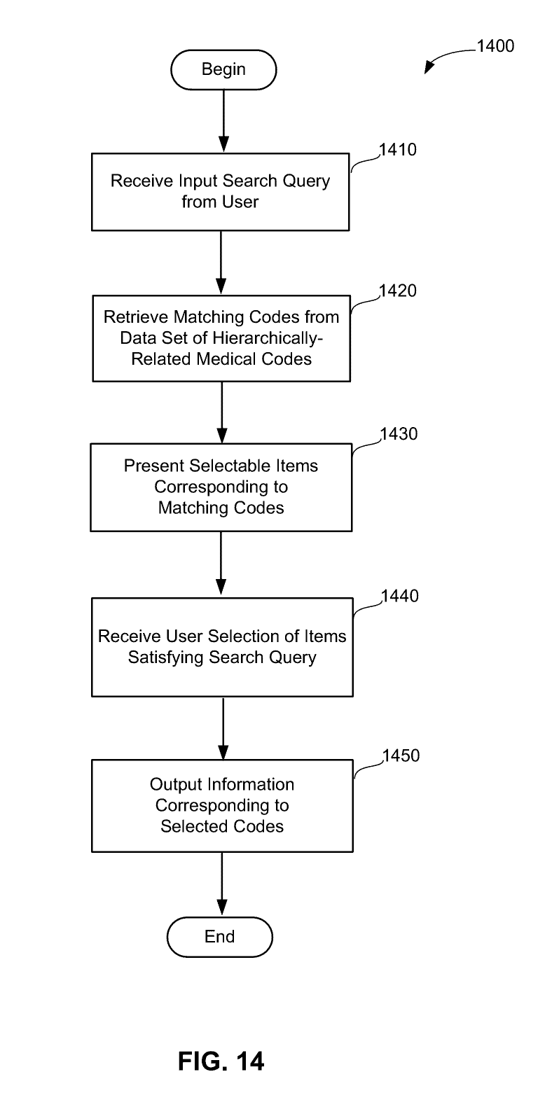

It should be appreciated from the foregoing that one embodiment of the invention is directed to a method 1400 for medical code searching, as illustrated in FIG. 14. Method 1400 may be performed, for example, by one or more components of a medical documentation system 100 such as code search component 106, although other implementations are possible, as method 1400 is not limited in this respect. Method 1400 begins at act 1410, at which an input search query may be received from a user, e.g., via an electronic user interface. At act 1420, the input search query may be automatically processed to retrieve one or more matching codes from a data set of hierarchically-related medical codes. Exemplary techniques for retrieving such matching codes relevant to an input search query are described above. In some embodiments, retrieving the matching codes may include retrieving generic matching codes and their more specific subcodes, although not all of the retrieved codes may be presented to the user at once, and some subcodes may not eventually be presented (e.g., if their parent codes are not selected by the user), as discussed above. In some embodiments, all of the subcodes of a generic matching code may be retrieved as matching codes relevant to the input search query, even if not all of the subcodes contain the query keywords in their text fields (e.g., the subcodes may be implicated in the keyword match exhibited by the parent code).

At act 1430, one or more selectable items may be presented to the user in response to the input search query, each selectable item corresponding to one of the matching codes retrieved from the code set. As discussed above, in some embodiments the presentation of selectable items in response to the input search query may include multiple sequential screens presenting specific child codes in turn after one or more generic parent codes are selected by the user. Thus, act 1440, at which a selection may be received from the user of one or more of the presented selectable items (which may be selected over multiple screens) as satisfying the input search query, may overlap (e.g., with interleaved parts) with act 1430 in some instances. As discussed above, in some embodiments, the user may be permitted to include in the selection (e.g., in one or more of the presented screens) two or more items corresponding to matching codes at the same level of hierarchy, as both/all satisfying the input search query, at least partially (as some may be revised by further selection of more specific child codes). Finally, at act 1450, information corresponding to the selected codes may be output. As discussed above, there may be many possible forms and content for the output, including in some examples intermediate output of information corresponding to codes selected “so far” being presented to the user during the process of presenting more specific code choices.

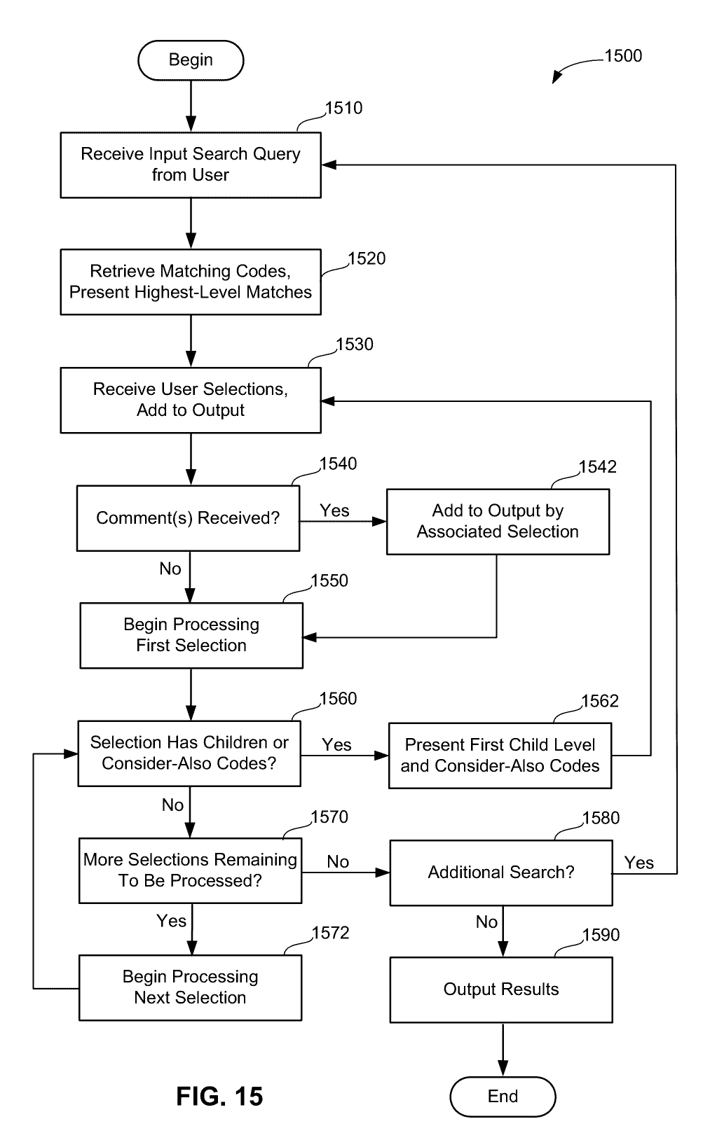

FIG. 15 illustrates another exemplary method 1500 for medical code searching in accordance with some embodiments. Method 1500 begins at act 1510, at which an input search query may be received from a user. At act 1520, the input search query may be processed to retrieve matching codes from a data set of hierarchically-related medical codes, and the highest-level (i.e., most generic) matches may be presented to the user for selection. As discussed above, in some embodiments, this may be done by presenting those matching codes that are not subcodes of other matching codes retrieved for the input search query. At act 1530, the user's selections of one or more of the presented codes (or information such as descriptive names representing the codes) may be received, and information corresponding to the selected codes may be added to the output for the search. If any free-form comments are received from the user at act 1540 in association with any of the selected codes, those comments may be added to the output at act 1542 in proximity to the associated selected code (or information corresponding thereto).

At act 1550, the method may then begin to sequentially process the code items selected by the user. At act 1560, a determination may be made as to whether the selected code currently being processed has any child codes or any associated consider- also codes. If so, at act 1562 the first level of child codes (i.e., the selected code's immediate children, as opposed to further removed descendant codes such as grandchild codes) and any consider-also codes may be presented to the user, and method 1500 may loop back to act 1530 to receive the user's selection(s) among those newly presented codes. At act 1570, if the selected code currently being processed does not have any further child codes or consider-also codes, a determination may be made as to whether any codes selected by the user remain to be processed. If so, at act 1572, processing of the next selected code may begin, and method 1500 may loop back to act 1560. If no selected codes remain to be processed, then at act 1580 the user may be provided an opportunity to request an additional search (e.g., with a new input search query, whose results are to be added to the existing output). If the user requests an additional search, then method 1500 may loop back to act 1510 at which the new input search query may be received. If the user does not request an additional search, then at act 1590, the accumulated output results may be finalized and output to any suitable destination, and method 1500 may end.

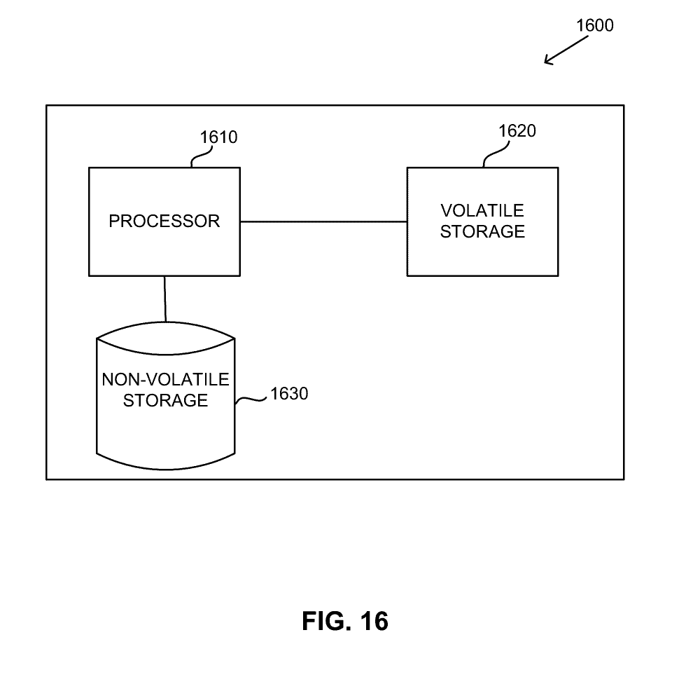

A system in accordance with the techniques described herein may take any suitable form, as embodiments are not limited in this respect. An illustrative implementation of a computer system 1600 that may be used in connection with some embodiments is shown in FIG. 16. One or more computer systems such as computer system 1600 may be used to implement any of the functionality described above. The computer system 1600 may include one or more processors 1610 and one or more computer-readable storage media (i.e., tangible, non-transitory computer-readable media), e.g., volatile storage 1620 and one or more non-volatile storage media 1630, which may be formed of any suitable non-volatile data storage media. The processor 1610 may control writing data to and reading data from the volatile storage 1620 and/or the non-volatile storage device 1630 in any suitable manner, as embodiments are not limited in this respect. To perform any of the functionality described herein, processor 1610 may execute one or more instructions stored in one or more computer-readable storage media (e.g., volatile storage 1620 and/or non-volatile storage 1630), which may serve as tangible, non-transitory computer-readable media storing instructions for execution by the processor 1610.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of some embodiments comprises at least one computer-readable storage medium (i.e., at least one tangible, non-transitory computer-readable medium, e.g., a computer memory (e.g., hard drive, flash memory, processor working memory, etc.), a floppy disk, an optical disc, a magnetic tape, or other tangible, non-transitory computer-readable medium) encoded with a computer program (i.e., a plurality of instructions), which, when executed on one or more processors, performs above-discussed functions. The computer-readable storage medium can be transportable such that the program stored thereon can be loaded onto any computer resource to implement techniques discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed techniques.

The phraseology and terminology used herein is for the purpose of description and should not be regarded as limiting. The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments in detail, various modifications and improvements will readily occur to those skilled in the art. Such modifications and improvements are intended to be within the spirit and scope of the invention.

Accordingly, the foregoing description is by way of example only, and is not intended as limiting. The invention is limited only as defined by the following claims and the equivalents thereto.

What is claimed is:

1. A method comprising:
processing an input search query, via execution of stored instructions by at least one processor, to retrieve from a data set of hierarchically-related medical codes one or more matching codes relevant to the input search query;
presenting to a user via an electronic user interface, in response to the input search query, one or more selectable items, each selectable item corresponding to one of the matching codes retrieved from the data set of hierarchically-related medical codes;
receiving from the user via the electronic user interface a selection of one or more of the presented selectable items as satisfying the input search query, wherein the user is permitted to include in the selection a first selectable item and a second selectable item as both satisfying the input search query, the first selectable item corresponding to a first matching code at a same level of hierarchy as a second matching code corresponding to the second selectable item; and
outputting information corresponding to the selected matching codes.

2. The method of claim 1, wherein the data set of hierarchically-related medical codes comprises International Classification of Diseases (ICD) codes.

3. The method of claim 1, wherein the first selectable item comprises a descriptive name of the first matching code.

4. The method of claim 1, wherein the first and second matching codes are sibling codes in the data set of hierarchically-related medical codes.

5. The method of claim 1, further comprising, in response to receiving from the user a selection of the first selectable item as satisfying the input search query, presenting to the user via the electronic user interface one or more selectable items corresponding to one or more child codes of the first matching code.

6. The method of claim 5, further comprising, in response to receiving from the user a selection of a selectable item corresponding to a child code of the first matching code, revising the output information to replace information corresponding to the first matching code with output information corresponding to the selected child code.

7. The method of claim 1, further comprising, in response to receiving from the user a selection of the first selectable item as satisfying the input search query, presenting to the user via the electronic user interface one or more selectable items corresponding to one or more non-child consider-also codes of the first matching code.

8. The method of claim 1, further comprising:
receiving from the user via the electronic user interface a first free-form comment in association with selecting the first selectable item as satisfying the input search query, and a second free-form comment in association with selecting the second selectable item as satisfying the input search query; and
including in the output information the first free-form comment in proximity to identifying information of the first matching code, and the second free-form comment in proximity to identifying information of the second matching code.

9. At least one computer-readable storage medium storing computer-executable instructions that, when executed, perform a method comprising:
processing an input search query to retrieve from a data set of hierarchically- related medical codes one or more matching codes relevant to the input search query;
presenting to a user via an electronic user interface, in response to the input search query, one or more selectable items, each selectable item corresponding to one of the matching codes retrieved from the data set of hierarchically-related medical codes;
receiving from the user via the electronic user interface a selection of one or more of the presented selectable items as satisfying the input search query, wherein the user is permitted to include in the selection a first selectable item and a second selectable item as both satisfying the input search query, the first selectable item corresponding to a first matching code at a same level of hierarchy as a second matching code corresponding to the second selectable item; and
outputting information corresponding to the selected matching codes.

10. The at least one computer-readable storage medium of claim 9, wherein the data set of hierarchically-related medical codes comprises International Classification of Diseases (ICD) codes.

11. The at least one computer-readable storage medium of claim 9, wherein the first selectable item comprises a descriptive name of the first matching code.

12. The at least one computer-readable storage medium of claim 9, wherein the first and second matching codes are sibling codes in the data set of hierarchically-related medical codes.

13. The at least one computer-readable storage medium of claim 9, wherein the method further comprises, in response to receiving from the user a selection of the first selectable item as satisfying the input search query, presenting to the user via the electronic user interface one or more selectable items corresponding to one or more child codes of the first matching code.

14. The at least one computer-readable storage medium of claim 13, wherein the method further comprises, in response to receiving from the user a selection of a selectable item corresponding to a child code of the first matching code, revising the output information to replace information corresponding to the first matching code with output information corresponding to the selected child code.

15. The at least one computer-readable storage medium of claim 9, wherein the method further comprises, in response to receiving from the user a selection of the first selectable item as satisfying the input search query, presenting to the user via the electronic user interface one or more selectable items corresponding to one or more non- child consider-also codes of the first matching code.

16. The at least one computer-readable storage medium of claim 9, wherein the method further comprises:
receiving from the user via the electronic user interface a first free-form comment in association with selecting the first selectable item as satisfying the input search query, and a second free-form comment in association with selecting the second selectable item as satisfying the input search query; and
including in the output information the first free-form comment in proximity to identifying information of the first matching code, and the second free-form comment in proximity to identifying information of the second matching code.

17. Apparatus comprising:
at least one processor; and
at least one processor-readable storage medium storing processor-executable instructions that, when executed by the at least one processor, perform a method comprising:
processing an input search query to retrieve from a data set of hierarchically-related medical codes one or more matching codes relevant to the input search query;
presenting to a user via an electronic user interface, in response to the input search query, one or more selectable items, each selectable item corresponding to one of the matching codes retrieved from the data set of hierarchically-related medical codes;
receiving from the user via the electronic user interface a selection of one or more of the presented selectable items as satisfying the input search query, wherein the user is permitted to include in the selection a first selectable item and a second selectable item as both satisfying the input search query, the first selectable item corresponding to a first matching code at a same level of hierarchy as a second matching code corresponding to the second selectable item; and
outputting information corresponding to the selected matching codes.

18. The apparatus of claim 17, wherein the method further comprises, in response to receiving from the user a selection of the first selectable item as satisfying the input search query, presenting to the user via the electronic user interface one or more selectable items corresponding to one or more child codes of the first matching code.

19. The apparatus of claim 17, wherein the method further comprises, in response to receiving from the user a selection of the first selectable item as satisfying the input search query, presenting to the user via the electronic user interface one or more selectable items corresponding to one or more non-child consider-also codes of the first matching code.

20. The apparatus of claim 17, wherein the method further comprises:
receiving from the user via the electronic user interface a first free-form comment in association with selecting the first selectable item as satisfying the input search query, and a second free-form comment in association with selecting the second selectable item as satisfying the input search query; and
including in the output information the first free-form comment in proximity to identifying information of the first matching code, and the second free-form comment in proximity to identifying information of the second matching code.
